(19) United States
(12) Patent Application Publication
(10) Pub. No.: US 2024/0352182 A1
(43) Pub. Date: Oct. 24, 2024

(54) POLYMERS AND CO-POLYMERS FOR POLYMER MATRIX COMPOSITES AND HIGH YIELD CARBON-CARBON COMPOSITE STRUCTURES THEREFROM

(71) Applicant: Mississippi State University, Starkville, MS (US)

(72) Inventors: Dennis W. Smith, Starkville, MS (US); Behzad Farajidizaji, Starkville, MS (US); Ernesto I. Borrego, Starkville, MS (US)

(21) Appl. No.: 18/761,009

(22) Filed: Jul. 1, 2024

Related U.S. Application Data
(63) Continuation-in-part of application No. 17/701,583, filed on Mar. 22, 2022.
(60) Provisional application No. 63/524,577, filed on Jun. 30, 2023.
(60) Provisional application No. 63/164,448, filed on Mar. 22, 2021.

(51) Int. Cl. C08G 61/10; C01B 32/05

(52) U.S. Cl. CPC C08G 61/10; C01B 32/05; C08G 2261/11; C08G 2261/124; C08G 2261/1412; C08G 2261/1422; C08G 2261/148; C08G 2261/149; C08G 2261/228; C08G 2261/314

(57) ABSTRACT

Provided herein are a polymer resin and a polymer network. The polymer resin includes at least one cyclopolymerized ortho-diynylarene (ODA) monomer and is processable at a temperature of less than 200° C. The polymer network includes a network formed from the polymer resin.

### PRIOR APPLICATIONS

The present invention claims priority to U.S. application Ser. No. 17/701,583, filed Mar. 22, 2022, which claims benefit of U.S. Application No. 63/164,448, filed on Mar. 22, 2021. This application also claims benefit of U.S. Provisional Application Ser. No. 63/524,577, filed Jun. 30, 2023. These applications are incorporated herein by reference.

### TECHNICAL FIELD

The present invention relates to carbon-carbon composite (CCC) structures and methods of synthesizing the same. In particular, the presently-disclosed subject matter relates to the preparation of CCC structures from carbon fiber and ortho-diynylarene (ODA) monomers and resins.

### BACKGROUND

Carbon-carbon composite (CCC) structures are used in a variety of applications. However, the current methods for forming CCCs are over 50 years old, time consuming, costly, and plagued with less than reliable final properties, particular interlaminar properties. These existing methods use phenolic resins that give poor yield, poor consolidation, and require multiple “back-filling” to produce a commercially useful CCC structure. Poor mechanical properties are due, in large part, to the unavoidable mass loss during pyrolysis resulting in high porosity when using traditional phenolic resin chemistry. This is partially addressed by re-infusion and re-pyrolysis (either with liquid or gaseous sources of additional carbon), but these processes are diffusion-dominated, and their effectiveness (particularly reproducibly) rapidly declines as part complexity and size increases. This major obstacle remains unaddressed since the pyrolysis/graphitization of current phenolic resins do not include mechanistic pathways for achieving high carbon yield (>70%) toward the goal of single fill consolidation enabling rapid and reliable part production. As such, the current methods are severely limiting progress, particularly in advanced applications such as hypersonic vehicles in extreme temperature environments (1000+° C.).

Accordingly, there remains a long standing need in the art for improved articles and methods of forming CCCs.

### SUMMARY

The presently-disclosed subject matter meets some or all of the above-identified needs, as will become evident to those of ordinary skill in the art after a study of information provided in this document.

This Summary describes several embodiments of the presently-disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this Summary or not. To avoid excessive repetition, this Summary does not list or suggest all possible combinations of such features.

In some embodiments, the presently-disclosed subject matter is directed to a polymer resin including at least one cyclopolymerized ortho-diynylarene (ODA) monomer selected from the group consisting of a bis-o-diynylarene (BODA) monomer, a mono-o-diynylarene (MODA) monomer, and a combination thereof, wherein the resin is processable at a temperature of less than 200° C. In some embodiments, the polymer resin comprises a copolymerized resin of BODA and MODA monomers. In some embodiments, the BODA monomer includes a structure according to Formula I:

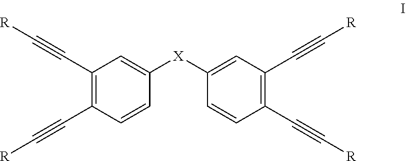

where X includes O, C(CF₃)₂, or a bond, and each R independently includes H, alkyl, alcohol, trimethylsilyl, aryl, or a substituted version thereof. In some embodiments, the alkyl is a C₂-C₁₀ alkyl. In some embodiments, the C₂-C₁₀ alkyl is selected from the group consisting of a C₅ alkyl and a C₈ alkyl. In some embodiments, the aryl includes a 5 or 6 membered ring. In some embodiments, the aryl is a heterocyclic aryl. In some embodiments, the heterocyclic aryl includes a nitrogen or sulfur atom. In some embodiments, each R is independently selected form the group consisting of H,

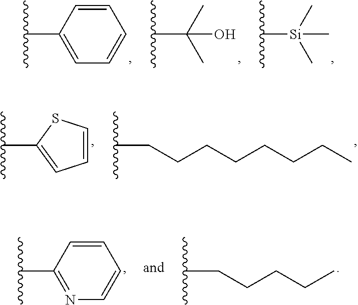

In some embodiments, the MODA monomer includes a structure according to Formula III:

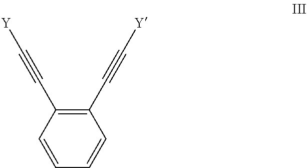

wherein each of Y and Y′ independently includes H or aryl. In some embodiments, the aryl includes a phenyl. In some embodiments, one of Y or Y′ includes aryl and the other includes H. In some embodiments, both Y and Y′ include H.

In some embodiments, the resin includes a structure according to Formula IVa:

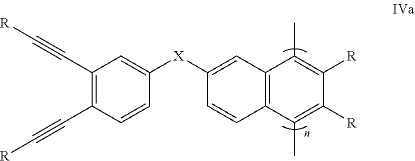

where X includes O, C(CF₃)₂, or a bond; each R independently includes H, alkyl, alcohol, trimethylsilyl, aryl, or a substituted version thereof; and n is a variable controlled by reaction times. In some embodiments, the resin includes a structure according to Formula IVb:

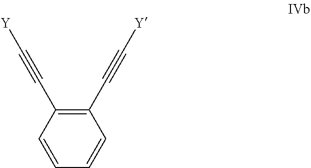

wherein each of Y and Y′ independently includes H or aryl.

Also provided herein, in some embodiments, is a polymer network including a structure according to Formula V:

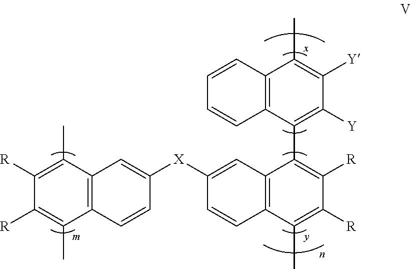

where X includes O, C(CF₃)₂, or a bond; wherein each R independently includes H, alkyl, alcohol, trimethylsilyl, aryl, or a substituted version thereof; each of Y and Y′ independently includes H or aryl; and m, n, x, and y are variable molecular weights controlled by time and temperature. In some embodiments, the polymer network is crosslinked. In some embodiments, the polymer network is carbonized. In some embodiments, the polymer network is selected from the group consisting of a polymer matrix composite (PMC) and a carbon-carbon composite (CCC). In some embodiments, the polymer network further includes one or more bundles of carbon fibers.

Further features and advantages of the presently-disclosed subject matter will become evident to those of ordinary skill in the art after a study of the description, figures, and non-limiting examples in this document.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 shows a schematic illustrating synthesis and polymerization of ODA monomers with variable spacer (X) and terminal groups (R, Y) for rate, processability, and ultimate property control. Synthesis of BODA monomers B1-B3 and the melt processable oligomers derived therefrom by means of homo-and copolymerization with M1-M3.

FIG. 2 shows a schematic and graph illustrating bis-o-diynylarene (BODA) 1-3 polymerization via DSC (10° C./min) and DMA (parallel plate at 210° C.).

FIGS. 3A-B show images and graphs illustrating polymerization. (A) MODA (4-6) homopolymerization. (B) BODA/MODA copolymerization by DSC (10° C./min).

FIG. 4 shows SEM micrographs illustrating the cross section fracture surface for BODA-Ether (2) derived CCC formed at 1000° C. (a-d), and the same pyrolyzed at 1500° C. (e-f).

FIG. 5 shows an image illustrating the structure of a polysilane containing BODA monomer.

FIG. 6 shows a schematic comparing the polymerization of previous diynes (left) by linear oxidative addition (Glasier coupling) and nickel catalyzed cyclotrimerization with a reagent and catalyst-free, thermal-initiated cycloaromatization of ODA monomers to high carbon yielding polynaphthalene derivatives according to an embodiment disclosed herein.

FIG. 7 shows a schematic illustrating synthesis of BODA monomers B1-B3 and the melt processable oligomers derived therefrom by means of homo- and copolymerization with M1-M3.

FIG. 8 shows a graph illustrating carbonization schedule for the fabrication of BODA derived C/C composites.

FIGS. 9A-D show graphs illustrating reactivity and thermal-stability profiles. (A) DSC overlay of B1-B3 and M1-M3 at 10° C./min with 50 cm³/min of N₂. (B) TGA (3° C./min, in argon) of BODA monomers B1-B3 carbonization. (C) First DSC cycle of the melt polymerization of B2 and M2 to homo- and copolymers B2:M2 in a (1:1) mole ratio. (D) TGA (10° C./min, in argon) observing the carbonization of B3 and M3 derived homo- and copolymers in a (3:1), (1:1), and (1:3) mole ratio of B3:M3.

FIG. 10 shows SEM micrographs illustrating the cross section of a mechanically fractured B2-derived C/C composite fabricated at 1000° C. in Argon. Frame (a) containing >1000 fibers.

FIG. 11 shows SEM micrographs exhibiting the cross section of a mechanically fractured B2-derived C/C composite, taken to 1500° C. for 3 hours in argon.

FIG. 12 shows images illustrating structures of mono-ortho-diynylarene (MODA) and bis-ortho-diynylarene (BODA) monomers, where “X” represents the different bridging groups for the BODA monomer.

FIG. 13 shows a schematic illustrating heat initiated Bergman Cyclization.

FIG. 14 shows a schematic illustrating mono-ortho-diynylarene (MODA) monomer synthesis. This reaction is accomplished via Sonagashira coupling.

FIG. 15 shows a schematic illustrating the current synthetic route to bis-ortho-diynylarene (BODA) monomers, where X is O, C(CF₃)₂, or a bond.

FIG. 16 shows a graph illustrating differential scanning calorimetry (DSC) for bis-ortho-diynylarene (BODA) monomers.

FIG. 17 shows a schematic illustrating distinct homo-polymerization of MODA substitution variants. Three variants of MODA undergoing heat-initiated polymerization in DSC are shown.

FIG. 18 shows a graph illustrating differential scanning calorimetry (DSC) for MODA monomers. The DSC of the three different variants of MODA.

FIG. 19 shows a schematic illustrating heat initiated co-polymerization of biphenyl MODA and BODA ether in DSC.

FIG. 20 shows a graph illustrating MODA and BODA ether co-polymerization at different heating rates.

FIG. 21 shows a graph illustrating TGA of BODA monomers. TGA 1000° C. at 3° C./min in nitrogen.

FIG. 22 shows a graph illustrating TGA of BODA monomers with carbon fiber. TGA 1000° C. at 3° C./min in nitrogen.

FIG. 23 shows a graph illustrating infrared spectroscopy of the BODA 6F monomer and the glassy carbon after carbonization.

FIG. 24 shows a graph illustrating infrared spectroscopy of BODA biphenyl and the glassy carbon after carbonization.

FIG. 25 shows a graph illustrating infrared spectroscopy of BODA ether monomer and the glassy carbon after carbonization.

FIG. 26 shows an SEM image illustrating a cross sectional view of a BODA ether composite at 1000° C.

FIG. 27 shows an SEM image of BODA ether composite at 1000° C. The image shows signs of minimal voids and good fiber and matrix interaction.

FIG. 28 shows an SEM image illustrating a cross sectional view of a BODA ether composite at 1500° C. This fiber pull out shows the cross section interaction between the carbon fiber and the polymer matrix composite.

FIG. 29 shows an SEM image illustrating a cross sectional view of a BODA ether composite at 1500° C.

FIG. 30 shows an image illustrating a cross section of a hexafluoropropane derived BODA polymer matrix in a novel CCC, infused without vacuum or mechanical pressing and cured at 1000° C. for 2 hours.

FIG. 31 is SEM cross-sections of BDR carbon illustrating the of effect of cure rate from 25-400° C. and Carbonization Rate from 400-1000° C. on carbon quality and void content.

FIG. 32A-C is SEM cross sections of a neat BODA-derived carbon prepared at different heating rates: (a) 1° C./min (b) 20° C./min and (c) 100° C./min. Micrographs are captured at scales wherein the first surface features become observable

FIG. 33A-C is SEM cross sections of a neat BODA-derived carbon prepared at different heating rates: (a) 1° C./min (b) 20° C./min and (c) 100° C./min. Micrographs are captured at scales wherein the first surface features become observable.

FIG. 34 shows BODA Bipheny; (B3) derived carbon crystallinity via Raman (ID/IG, increasing ID/IG is decreasing crystallinity) and XRD (%) as a function of carbonization rate.

FIG. 35A-B shows (a) Variable linear heating rate TGA carbonization of B3 to 1000° C. (1273 K) in 50 mL/min of N2 (b) derivative conversion/temperature curves with conversion as a function of temperature inset.

FIG. 36A-F shows deconvoluted conversion vs temperature plots at different heating rates: (a) 1 K/min (b) 10 K/min (c) 20 K/min (d) 30 K/min (e) 50 K/min (f) 100 K/min.

FIG. 37A-B shows pyro-GC/MS analysis of a neat, cured BDR sample completed via a single shot flash pyrolysis: (a) chromatogram (b) mass spectra of the principal volatiles generated during carbonization.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently-disclosed subject matter, representative methods, devices, and materials are described herein.

Following long-standing patent law convention, the terms “a”, “an”, and “the” refer to “one or more” when used in this application, including the claims, unless the context clearly dictates otherwise. Thus, for example, reference to “a polypeptide” includes one or more of such polypeptides, and so forth.

Unless otherwise indicated, all numbers expressing quantities of ingredients,

properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Provided herein are articles and methods for forming a polymer and/or co-polymer resin. Unless stated otherwise, the polymer and/or co-polymer resin are collectively referred to herein as “resin” or “polymer resin.” In some embodiments, the resin is formed from one or more ortho-diynylarene (ODA) monomers. For example, in one embodiment, the resin is formed from one or more tetra-functional bis-o-diynylarene (BODA) monomers and/or one or more di-functional mono-o-diynylarene (MODA) monomers.

In some embodiments, the BODA monomer includes a structure according to Formula I:

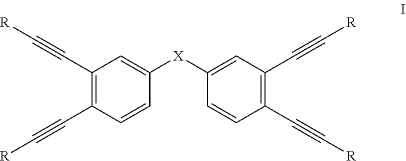

where X is O, C(CF₃)₂, or a bond; and each R independently includes H, alkyl, alcohol, trimethylsilyl, aryl, or substituted version thereof. In some embodiments, the alkyl is a C₂-C₁₀ alkyl, such as, but not limited to, a C₅ alkyl or a C₈ alkyl. In some embodiments, the aryl includes a 5 or 6 membered ring. In some embodiments, the aryl is heterocyclic. For example, in some embodiments, the aryl includes a nitrogen or sulfur atom, such as, but not limited to, thiophene or pyridine. In some embodiment, each R is independently selected from the group comprising:

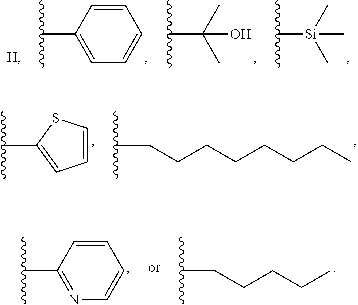

In some embodiments, the BODA monomer is formed from a bis-phenol. The BODA monomer may be formed from any suitable bis-phenol, such as, but not limited to, those shown in Formula II:

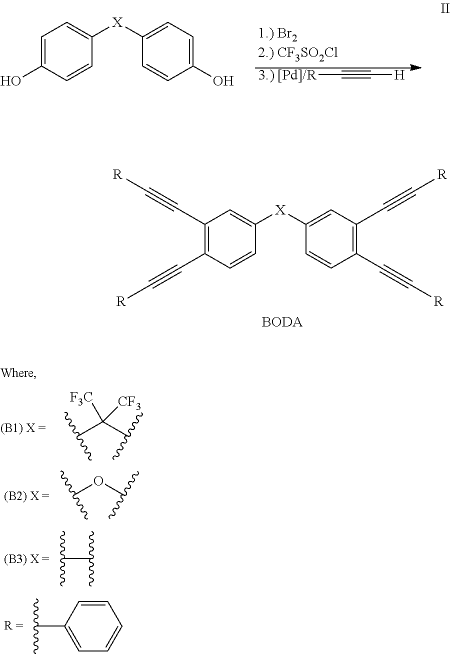

Still referring to Formula II, in some embodiments, the reaction conditions for forming the BODA monomer from the bis-phenol include 1) bromination via electrophilic aromatic substitution; 2) Triflate esterification; and 3) Pd cross-coupling. As will be appreciated by those skilled in the art, the disclosure is not limited to the bis-phenols or BODA monomers shown in Formula II and expressly includes any other suitable bis-phenol to produce any desirable BODA monomer. As will also be appreciated by those skilled in the art, the reaction conditions discussed above and shown in Formula II can be applied to the other suitable starting bis-phenols.

In some embodiments, the MODA monomer includes a structure according to Formula III:

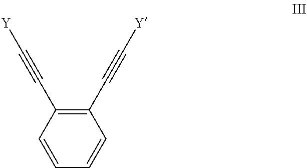

where each of Y and Y′ independently includes H or aryl. In some embodiments, the aryl includes a phenyl. For example, in one embodiment, both Y and Y′ include phenyl. In another embodiment, one of Y or Y′ includes phenyl and the other includes H. In another embodiment, both Y and Y′ include H.

In some embodiments, the resin formed from the one or more BODA monomers and/or one or more MODA monomers includes a structure according to Formula IV:

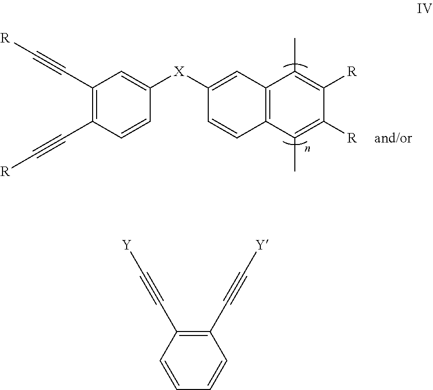

where X, R, Y and Y′ are as defined above, and n is a variable controlled by reaction times. In some embodiments, X is a bond and both Y and Y′ are phenyl. In some embodiments, the resin is able to be processed at a temperature of less than 200° C. Additionally or alternatively, in some embodiments, the resin provides a char yield of at least 70%. In some embodiments, the resin includes one or more of the properties discussed in the Examples below.

Also provided herein is a method of forming the resin. In some embodiments, forming the resin includes the thermal cyclopolymerization of the ODA monomers. For example, in some embodiments, the thermal cyclopolymerization includes polymerization of the one or more BODA monomers. Alternatively, in some embodiments, the thermal cyclopolymerization includes copolymerization with the one or more BODA monomers and the one or more MODA monomers to provide desired rheological properties. In some embodiments, the thermal cyclopolymerization proceeds via the radical mediated Bergmann cyclization without catalysts or initiators. Additionally or alternatively, in some embodiments, the resin is formed free of condensates or side products. In some embodiments, the conditions of the thermal cyclopolymerization are selected to form the resin with any suitable molecular weight. Suitable molecular weights of the resin include, but are not limited to, 1500-25,000 kDa. For example, the thermal cyclopolymerization may include non-oxidative reaction conditions of 1) 250° C. for 4, 6, 12, and 24 hrs in diphenyloxide; 2) 210° C. for 4 hrs in melt; and 3) 250° C. for 2 hrs in melt to form the resin intermediate with a molecular weight of between 1500-25,000 kDa. In some embodiments, reaction condition 3) produces a completely cross-linked sample for most ODA copolymer combinations.

In some embodiments, the resin is further processed to form a polymer network. In some embodiments, the polymer network is crosslinked. In some embodiments, the polymer network includes a structure according to Formula V:

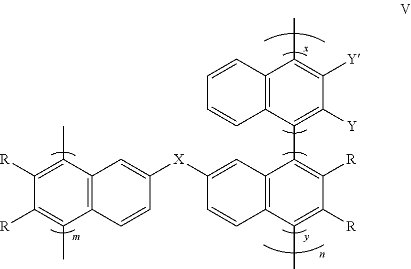

where X, R, Y, and Y′ are as defined above; and m, n, x, and y represent variable molecular weights that are controlled by time and temperature. In some embodiments, the polymer network is capable of wetting and holding bundles of carbon fibers free of voids along with corresponding carbon yields. Accordingly, in some embodiments, the resin may be combined with carbon fiber bundles prior to processing.

Suitable techniques for forming the polymer network include, but are not limited to, melt processing, thermal curing, or a combination thereof. For example, in some embodiments, processing the resin includes thermal processing via extrusion, infusion, coating, micro/nano-molding, or a combination thereof. In some embodiments, the processing further includes thermal curing. In some embodiments, the thermal curing includes exposing the processed resin to temperatures of at least 450° C. Other suitable techniques include, but are not limited to, solution processing, spin-coating, or micro-molding.

Additionally or alternatively, in some embodiments, the resin and/or polymer network is carbonized. In some embodiments, for example, the carbonization includes exposing the processed resin to a temperature of 1000° C. In some embodiments, carbonization includes exposing the processed resin to temperatures above 1500° C. In some embodiments, exposing the processed resin to a temperature of 1000° C. or more causes pyrolysis, which yields a glassy carbon. In some embodiments, the resins and/or polymer networks according to one or more of the embodiments disclosed herein are capable of withstanding high carbonization temperatures while maintaining thermal stability and high performance.

The polymer network formed according to one or more of the embodiments disclosed herein includes, but is not limited to, a polymer matrix composite (PMC) and/or a carbon-carbon composite (CCC). These polymer networks are useful for a variety of applications such as, but not limited to, thin film dielectrics, light emitting diodes, inverse carbon opals, three-dimensional (3D) printing, and as precursors to any other suitable carbon structure. In some embodiments, the polymer networks form PMCs and/or CCCs with extreme environment stability (e.g., resistance to high heat (e.g., at least 1000° C.), oxidative resistance, chemical resistance). In some embodiments, the polymer networks may be used in hypersonic aircraft; missiles; other high speed atmosphere, LEO, or space vehicles; ground based automotive and other high performance carbon applications (high ablation, impact, and wear resistance, etc.); or any other suitable extreme environment application for PMCs and/or CCCs. Additionally or alternatively, in some embodiments, the polymer networks may be used in less extreme or non-extreme conditions, such as, but not limited to, electrodes, filters, electronics, or any other suitable carbon application.

Without wishing to be bound by theory, it is believed that the articles and methods disclosed herein provide an unprecedented high yield of CCC structures from carbon fiber and ODA derived polymers. For example, in some embodiments, the methods disclosed herein provide a high yield (e.g., over 80%) of carbonized structures after micro-and nano-molding. Once again, without wishing to be bound by theory, it is believed that this high yield represents an extreme and unique processability and performance balance never before applied to polymer matrix composites (PMC) or carbon/carbon composites (CCC). Additionally or alternatively, in some embodiments, the monomers disclosed herein exhibit higher carbon content than the existing phenolic resins used as carbon precursor polymer matrices in CCCs, thereby releasing less condensates upon carbonization, and thus requiring less resin infusions and creating a more cost-efficient process for the large scale production of CCCs.

The presently-disclosed subject matter is further illustrated by the following specific but non-limiting examples. The following examples may include compilations of data that are representative of data gathered at various times during the course of development and experimentation related to the presently-disclosed subject matter.

### EXAMPLES

### Example 1

This Example describes a synthetic materials approach that establishes new advanced resin technology for CCC manufacture featuring (1) enhanced “dialed-in” elements of processability (rheology, cure kinetics, etc.), and (2) unprecedented carbon yield complete in one infusion and elimination of currently required back-fill and re-infusion steps. Today, standard matrix resins based on 50+ years old phenolic technology require between 4-7 infusions (e.g., ACC-n, for n number of infusions, commonly 6). Mass loss during multiple infusion/carbonization cycles results in property killing voids within the matrix and necessitates re-densification through a greater number of infusions. However, re-infused pre-carbon matrices used today also tend to carbonize around pores forming closed cell structures. Therefore optimal densities and properties are not only unachievable, part reproducibility and overall structure specification tolerances preclude performance reliability.

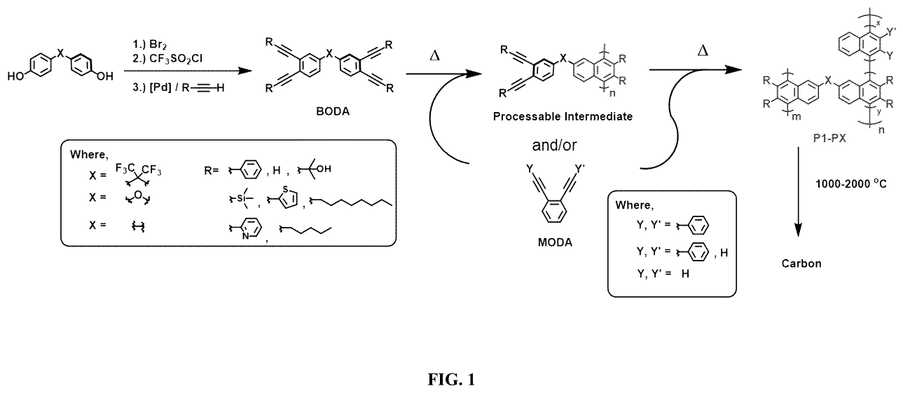

To confront these severe limitations to CCC technology, a Ortho-Diynyl Arene (ODA) resin chemistry platform was developed based upon multi-functional co-monomers with controllable reactivity. Tetra-functional bis-ortho-diynylarene (BODA) and di-functional mono-ODA or MODA monomers are prepared in three simple steps from commercial phenols via selective bromination, triflate esterification, and Pd-catalyzed Sonogashira coupling with R-substituted alkynes (FIG. 1). Thermal polymerization proceeds via processable branched intermediate oligomers to variable molecular weight, PDI, and thus rheological properties for carbon fiber matrix infusion, network formation, and carbonization as shown in FIG. 1.

Due to their unprecedented carbon yields, BODA and MODA co-monomers are being studied by the present inventors for use as matrix resins for CCC applications (Table 1). Originally developed as interlayer dielectric resins for microelectronics due to their excellent solution spin-on, gap fill, and thermal properties of the network in its pre-carbonized state, micro-and nano-processing of BODA derivatives and their pyrolysis to carbon materials was later reported. Weight lost during carbonization results from volatilization of heteroatoms during pyrolysis of the polymer matrices, and thus is a function of the elemental composition of the starting material.

TABLE 1
Composition and Carbon Yield at 1000° C. for selected precurusors.

| Monomer | % C | % H | % X¹ | Carbon yield |
|---|---|---|---|---|
| BODA-Biphenyl (3)² | 95 | 5 | <1 | 82% |
| BODA-Ether(2)² | 94 | 4 | 2 | 75% |
| BODA-6F (1)² | 80 | 4 | 16 | 72% |
| Novolac³ | 79 | 64 | 1 | ~45% |

¹Heteroatoms: N, O, F, etc.
²Carbonized without pressure, carbon yields are from polymer to glassy carbon pyrolysis at 1000° C.
³Theoretical elemental composition computed from oligomer structure of Novolac, carbon yield from Economy, et al., Carbon 30.1 (1992).

Familiar polyarylacetylene (PAA) matrices were also reported to give exceptionally high carbon yields upon pyrolysis at elevated pressures in the single-step fabrication of CCCs, yet they are generally limited by cost, hazards, and poor processability. The ODA strategy contains similar alkyne functionality as PAAs and other acetylenic resins, however unlike isolated alkynes which polymerize through a variety of pathways to ill-defined polyenes and aromatics, ortho-diynlyarenes operate through a well-defined Bergman cyclization mechanism and give quantitative polynaphthalene enchainment. Additionally, as another important processing control “handle,” the Bergman cyclization rate is highly determined by the trans-alkyne distance dictated by the size of the alkyne terminal groups (e.g., phenyl, H, other). As shown in FIG. 1, initiator and catalyst free thermal polymerization of tetra-functional BODA and copolymerization with variable di-functional MODA monomers proceeds via highly processable branched intermediates with well-defined and controlled latent functional group reactivity and thus rheological and ultimate network and carbon properties. The ODA strategy offers clear processability/performance advantages over the state of the art commercial technology.

Processing parameter specific ODA derived intermediate resins can be blended, compounded and stored for later use in VARTM type carbon fiber infusion or other pre-impregnation processes. Processing windows can be tuned affording crosslinked networks via well-controlled kinetics up to and through gelation to final network cure temperature (400-1000° C.) depending on use temperature and thermal stability requirements (e.g., for dielectrics, 450° C. was the final target at which temperature BODA networks degraded at a rate of <1%/h isothermally). In agreement with Flory's theory for conversion at gelation, P_{gel}=1/f−1, where f is the average functionality for all monomers, BODA monomer homopolymerization (f=4) and MODA (f=2, no gelation statistically possible), conversion to gelation can be easily measured and controlled by co-monomer composition, time, and temperature from up to 33% alkyne conversion at gelation for pure BODA and higher (wider gel window for given T) as MODA composition is increased and total average f decreases. Once the prescribed PMC network structure or CCC preform is produced, additional fabrication steps, coatings, assembly, or immediate pyrolysis at 1000-2500° C. can be accomplished. Carbonization of the CCC preform ensues thermally via large fused polycyclic aromatic intermediates to glassy carbon with varying degrees of crystallinity or graphitization.

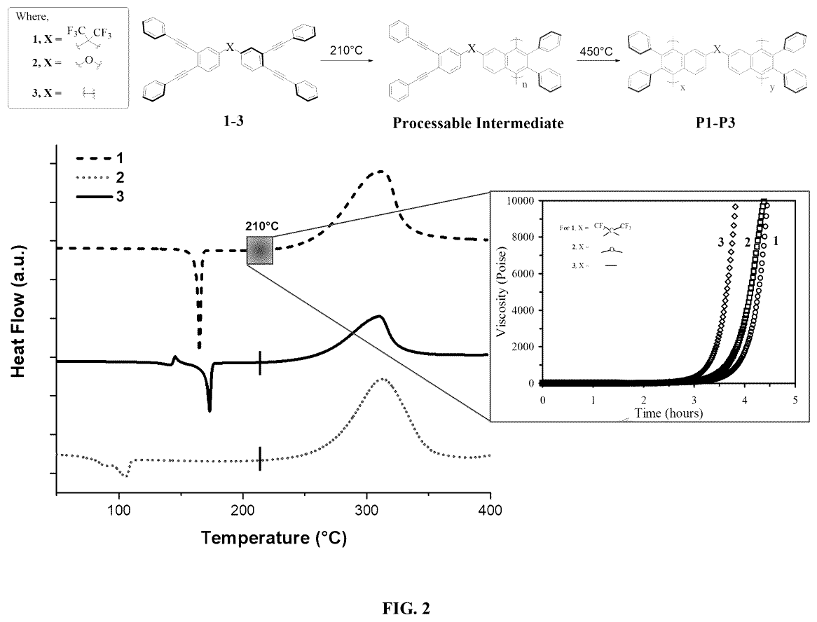

The DSC reactivity profiles help determine the carbonization schedule used in the fabrication of BODA derived composites (FIG. 2). The onset of the polymerization (Tₒₙₛₑₜ) does not occur in BODA resins 1-3 until ≥200° C., which gives a large melt processing windows prior to gelation. This allowed for the pseudo-solid phase impregnation of the carbon fiber preforms as the monomers had time to flow into and gel around the T300 fibers. BODA Ether (2) exhibits the lowest melting point (Tₘ) at 105° C. and shows the largest processing window, however it also produced lower carbon yields than the biphenyl derivative (3). Naturally, BODA-Biphenyl (3) exhibits the highest viscosity onset of the three monomers.

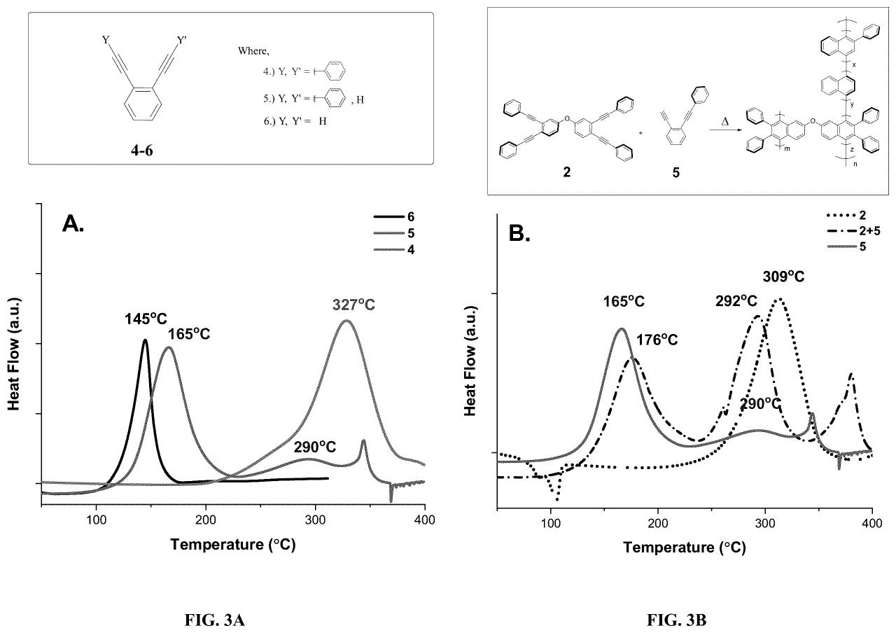

The reaction kinetics, rheology, and actual processability enhancements for ODA copolymerization are all dictated by monomer composition. DSC analyses of selected compositions have revealed exciting reaction profiles, wherein the greater reactivity of the variable substituted MODA monomer (Y, FIGS. 3A-B) will initiate copolymerization of BODA monomer at much lower temperature, indicating that the predicted control and expansion of the processing window is at hand. Therefore, the effect of monomer composition and terminal group substitution on reactivity, processability, and performance are the two most important variables for the synthetic study and down selection for scale-up and CCC part fabrication.

The present inventors have demonstrated fabrication of carbon fiber (T300) reinforced CC composites from BODA derived polyarylene networked matrices using a single ply of carbon fiber, which was contacted with monomer or b-staged oligomer in a ceramic boat. The fibers were subsequently covered with additional polymer to give 20-30 polymer wt %. For total impregnation, the polymer-fiber mix was placed inside of a Carbolite 1600° C. tube furnace wherein an inert atmosphere was established by flowing 50 cm³/min of Argon for 30 min before beginning the pyrolysis. The resulting composites were carbonized under ambient pressure and gave carbon yields between 71 and 82%, which are significant when compared against the yields obtained from the pyrolysis of currently used phenolic resins.

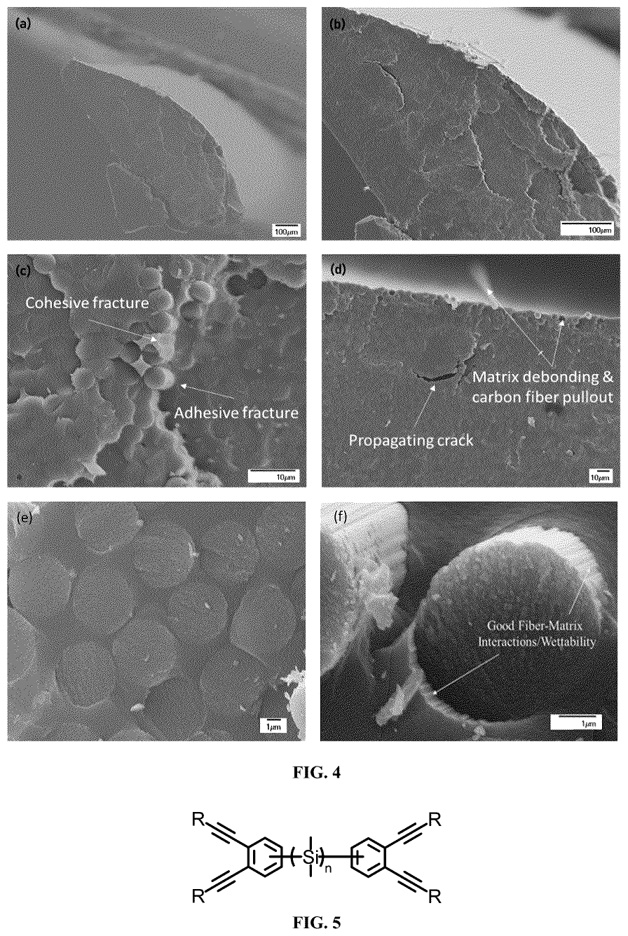

In addition to the reactivity and viscosity profiles of the monomers, cross-section fracture surfaces shown in FIG. 4 illustrate the capability of BODA 2 to wet the surface, flow and fill the fiber excluded volume, and penetrate the crevices/striations of the T300 fiber. These results support the feasibility of impregnating the fiber preform with BODA derived pre-carbon matrix polymers on a small scale. As can be observed from the micrographs, there are few voids within the matrix not due to common fiber pullouts and defects caused by fracture.

The results shown in this Example suggest a favorable fiber-matrix interaction. The surface adhesion is sure to be affected by the mechanical interlocking of the matrix and the striations on the fiber's surface. Covalent bonding is expected between the fiber (defect sites at least) and BODA resins due to the highly aggressive nucleophilic radicals produced and shown to selectively add to (and render soluble) carbon nano-onions, which although slightly strained and more reactive than flat carbon surfaces, approach the low reactivity of carbon fiber.

Without wishing to be bound by theory, it is believed that these resin systems may be used with conventional composite fabrication techniques.

### Example 2

Carbon-carbon composites are used for extreme, high temperature conditions (≥2000° C.) that also require oxidation protection in the form of a ceramic coating (e.g., βSiC, HfC). Typically this ceramic coating is made as a functionally graded material (FGM), either in terms of its porosity or composition from the carbon to the refractory carbide. This is because the mismatch in coefficients of thermal expansion (CTE) results in stress concentration between the carbon-ceramic interface when heating/cooling, yielding microcracks. By creating a functionally graded ceramic coating, it is possible to reduce the stress induced from the thermal mismatch and provide oxidation protection from within the composite when microcracks are formed. This is critical because any microcrack can allow oxygen to permeate through, where even small concentrations can cause catastrophic failure.

Without wishing to be bound by theory, to address this issue, it is believed that the matrix applications of ODA-derived polymers for CCC can be expanded to include the synthesis of polysilane, siloxane, boron, zirconia, and Hf, etc. containing ODA monomers (FIG. 5). Poly(dimethyl)silane is a known B-SiC precursor polymer via thermal rearrangement to the poly(methyl)carbonsilane intermediate followed by pyrolysis. The goal is to deliver functional monomers, which pyrloyze to form inorganic carbides, e.g., SiC or the like, preferentially concentrated at the surface by “self-grading” or by additive printing processes.

### Example 3

### BODA-MODA-Derived Resins for C/C Composite Technology

The present inventors have produced high quality carbon-carbon (C/C) composites

fabricated from bis-o-diynylarene (BODA) monomers. The most attractive monomer (BODA-Biphenyl; carbon yield 83%) has the highest melting point (Tₘ=173° C.). For current processing conditions this is unfavorable, as lower operating temperatures are desired for resin infusion and a melting temperature near the onset of polymerization risks gelation within machinery. Creating a co-monomer mixture with mono-o-diynylarene (MODA or diphenylethynylbenzene; Tₘ=50° C.), a high carbon yielding resin was obtained that could be processed under the current composite processing limits (˜150° C.).

### Procedure for BODA-MODA (1:1) Copolymerization in Melt

In a high pressure microwave vial, 67 mg (0.12 mmol) of BODA-Biphenyl and 33 mg (0.12 mmol) of MODA-DPEB are added with a stir bar. The vial is capped and deoxygenated by three purge cycles (vacuum/N₂). Under vacuum, the co-monomer mixture is then melted (in this 1:1 mixture, the melting temperature is ˜150-155° C.). Vacuum is held at this melt temperature while mixing, ensuring the proper removal of any trace amounts of solvent (associated with monomer synthesis), if any, while creating a completely homogenous mixture of the two co-monomers. This can be done in 1-2 hr. At these temperatures, the co-monomer mixture is free flowing (qualitatively, its flow is similar to water) yet once the mixture is taken to the onset of polymerization ˜250° C. the mixture is crosslinked within 2-3 hrs. This specific mixture can obtain a carbon yield around ˜73% at standard pressure.

### Example 4

There is currently a demand for making carbon-carbon (C/C) composites with the least number of resin infusions. Although standard matrices achieve between 4-7 infusions (e.g., ACC-4, ACC-6, ACC-7), current C/C composite literature lacks new pre-carbon matrix materials that are more efficient. During the carbonization of carbon-resin to C/C, voids within the matrix are formed which necessitate additional resin infusions for achieving higher densities and better mechanical properties. At a large scale this becomes extremely wasteful. Especially since reinfused resin tends to form closed cells by carbonizing over existing pores, optimal densities are rarely obtained. Weight loss is a result of the volatilization of heteroatomic condensates from the pre-carbon resin, and thus is a function of the initial elemental composition. See Table 2 for comparisons of phenolic and pitch resins, commonly used matrix materials, against the highly unsaturated monomers we propose herein.

TABLE 2
Elemental composition and carbon yields of traditionally employed pre-carbon
matrices and BODA-derived resins

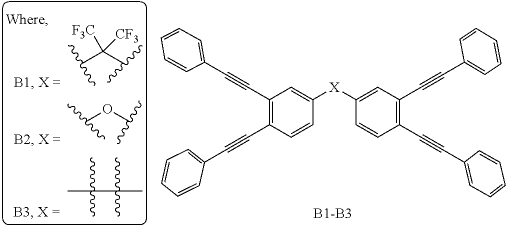

| RESIN | % C | % H | % X^{A} | CARBON YIELD |
|---|---|---|---|---|
| B1) BODA-6F^{B} | 80 | 4 | 16 | 72% |
| (B2) BODA-ETHER^{B} | 94 | 4 | 2 | 75% |
| (B3) BODA-BIPHENYL^{B} | 95 | 5 | <1 | 83% |
| NOVOLAC^{C} | 79 | 6 | 14 | ~45% |
| MESOPHASE PITCH^{D} | 93 | 4 | <1 | ~80% |

^{A}(% X) represents the percentage of any heteroatom (e.g., N, O, F).
^{B}Carbonized without pressure, carbon yields are from polymer to glassy carbon pyrolysis at 1000 °C. in argon, by the methods reported herein.
^{C}Theoretical elemental composition computed from oligomer structure of novolac, carbon yield from [2]
^{D}Data obtained from [1, 3].

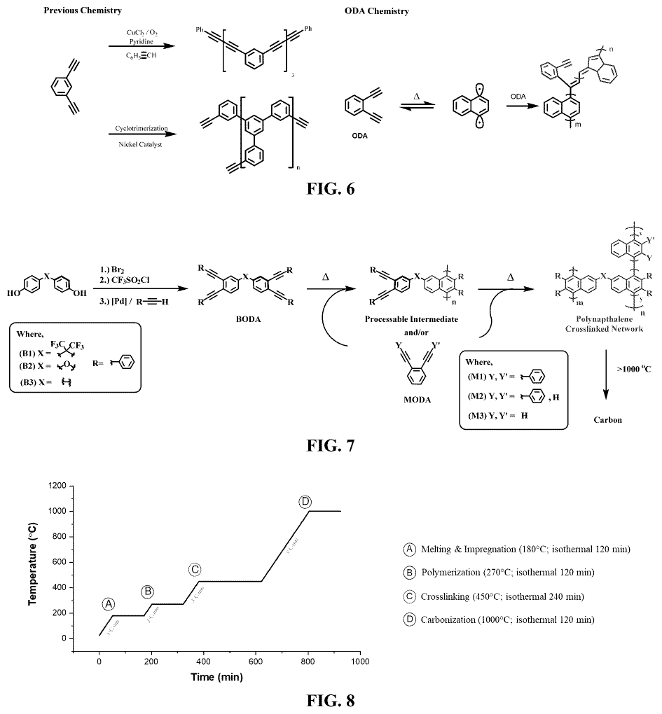

In the search for a more efficient process in fabricating these high temperature/high performance materials, the present inventors are studying bis-ortho-diynylarenes (BODAs) B1-B3 as matrix components for C/C composite applications. Originally developed for low-dielectric applications, the polynaphthalene networks derived from B1-B3 were soon found to be high carbon yielding in studies for potential applications in microelectromechanical systems (MEMS), and since then have been exploited to make solid and hollow carbon fibers, carbon-based photonic crystals, mesoporous carbon structures, and more. As shown herein, these ortho-diynes have now been found to show similar performances to that of polyarylacetylene (PAA) matrices, which gave ˜95% carbon yields upon pyrolysis at elevated pressures. Although PAAs allowed for the single-step fabrication of C/C composites, they are uneconomical and dangerous to work with. Because the BODA monomers contain the same functional groups but operate through different chemistry (FIG. 6), they maintain the same high carbon composition, integral to carbon production efficiency, while bypassing the dangers of the previously reported PAAs.

Thermal polymerization of B1-B3 proceeds via a radical-mediated cyclization to a didehydroaromatic (i.e., aryl diradical; FIG. 6) intermediate and its subsequent radical coupling to processable, branched oligomers with variable molecular weight, polydispersity index (PDI), and rheological properties. The radical-mediated cyclization of ortho-diynylarenes (ODAs), now known as the Bergman cyclization, has found ever increasing utility in polymer science: from making linear conjugated polymers and cross-linked networks, initiating radical polymerizations of olefins and acrylates, to forming polymeric nanoparticles, rigid rods, one-dimensional nanostructures, and an assortment of other polymer architectures. In this Example, BODA is presented as a unique class of chemically modifiable tetrafunctional ODA monomer capable of producing remarkably dense monolithic carbon structures suitable for C/C matrix applications upon its nonoxidative pyrolysis at 1000° C. BODA monomers are prepared in three simple steps from commercial bisphenols via selective bromination, triflate esterification, and Pd-catalyzed Sonogashira coupling with variably substituted acetylenes (FIG. 7). The structural versatility of these crosslinkers offers exceptional control in properties: variable (X) spacers can change crystallinity/solubility or impart thermal-oxidative stability in the produced carbon, while variable terminal alkyne groups (R/Y in FIG. 7) can influence processability, conjugation, viscosity, and reactivity. To this end, mono-ortho-diynylarene (MODA) monomers (M1-M3) with varying terminal alkyne groups are utilized as co-monomers to provide a pathway in controlling the reactivity and extending the processing window of B1-B3, while maintaining high carbon yields.

### Methods and Materials

### Materials

T300 carbon-fiber fabrics were supplied by Toray Carbon Fibers America, Inc. with a fiber diameter of 7 μm. Each of the BODAs were synthesized on a 100 g scale from a facile three step procedure described by Smith et al., Journal of the American Chemical Society, 1998. 120(35): p. 9078-9079. wherein all carbon tetrachloride was substituted with methylene chloride. All commercial bisphenols (4,4′-Biphenol; 2,2-Bis(4-hydroxyphenyl)hexafluoropropane; 4,4′-dihydroxyphenyl ether), bromine, trimethylsilylacetylene and phenylacetylene were purchased from Oakwood Chemical. Other reagents like trifluoromethanesulfonyl chloride and bis(triphenylphosphine)palladium(II) chloride were purchased from Synquest and Acros Organics, respectively. Solvents and additives like anhydrous dichloromethane, glacial acetic acid, triethylamine, and anhydrous dimethylformamide were obtained from Fisher Scientific. The (97×16×10 mm) porcelain combustion boats were purchased from United Scientific Supplies, Inc.

Differential scanning calorimetric (DSC) experiments were executed for the purpose of surveying the thermal reactivity profile of each ODA monomer and their comonomer formulations using a TA Q20 V4 DSC instrument. Approximately five to nine mg of the materials were placed in TA low-mass aluminum pan, sealed, and a heating/cooling cycle was carried out with a heating rate of 10° C./min from 30-400° C. Thermal degradations of the ODA-derived polymers and their subsequent carbon yields was experimentally investigated by analyzing small (5 to 10 mg) samples on a TA Q50 V20 thermogravimeteric analyzer (TGA), heating from 30-1000° C. at a heating rate of 10° C./min. Finally, a JEOL JSM-6500F field emission scanning electron microscope (SEM) was used for obtaining micrographs of the ODA-derived C/C microstructures.

### Fabrication of Composites

For the fabrication of carbon fiber (T300) reinforced composites with BODA-derived carbon matrices, a single ply of carbon fiber was placed onto a pre-measured amount of polymer in a ceramic boat. The fibers were subsequently covered with an amount of solid state polymer that totaled a 20-30 polymer-fiber wt %. For total impregnation, the polymer-fiber mix was placed inside of a Carbolite 1600° C. tube furnace wherein an inert atmosphere was established by flowing 50 cm³/min of Argon for 30 min before beginning the pyrolysis schedule shown in FIG. 8. The BODA monomers have a melting point of 165, 105, and 173° C. for B1-B3, respectively. Therefore, melting of the polymers was carried out at 180° C. The resulting C/C composites were carbonized without mechanical pressing or pressure of any kind and gave carbon yields between 71.3 and 82.1%.

### Results

### Reactivity and Thermal-Stability Profiles

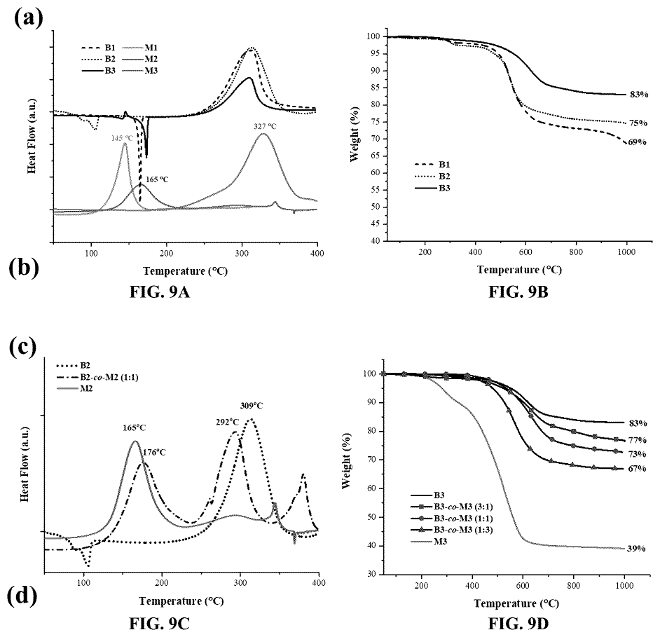

The reactivity profiles shown in FIG. 9A determined the carbonization schedule used in the fabrication of our composites (FIG. 8). The onset of the polymerization (Tₒₙₛₑₜ) does not occur in B1-B3 until ≥200° C. which provides a large processing window from where the monomers melt until they gel. This allowed for the pseudo-solid phase impregnation of the carbon fiber preforms, as the monomers had plenty of time to melt into the preform before curing and carbonizing around the T300 carbon fibers. BODA Ether (B2) exhibits the lowest melting point (Tₘ) at 105° C. and therefore has the largest processing window, however, it also produced slightly lower carbon yields than its biphenyl derivative (FIG. 9B and Table 2). Naturally, BODA-Biphenyl (B3) is the best choice in terms of carbon yields, rivaling that of pitch (Table 2), yet it has the highest melting point because of a smaller degree of freedom/rotation about the core phenyl rings—with an α crystalline state melting at 141° C. and recrystallizing into a β crystal, B3 ultimately melts at 173° C. and has the highest melt viscosity of the three monomers. Therefore, to extend the window of processability, copolymerization with MODAs, M1-M3, were carried out. These comonomers are structurally similar, react through the same chemistry, and are bifunctional. This bifunctional nature imparts a more linear character to the copolymer that extends the time to gel. In some comonomer mixtures, MODA can act as a reactive diluent (FIG. 9C) to the BODA monomer in a way that affords a pathway to thermally controlled branching and gelation based on the terminal alkyne groups (Y,Y′; FIGS. 7 and 9A) and overall composition. For the best results, B3 and M3 were utilized: M3, having a melting point of 50° C., could reduce the melting point of B3 and still have the same onset of polymerization (FIG. 9A), therefore creating a larger processing window. In varying compositions of these two comonomers (B3:M3) relatively high carbon yields were still achieved (FIG. 9D).

### The Morphology of T300/BODA Composites

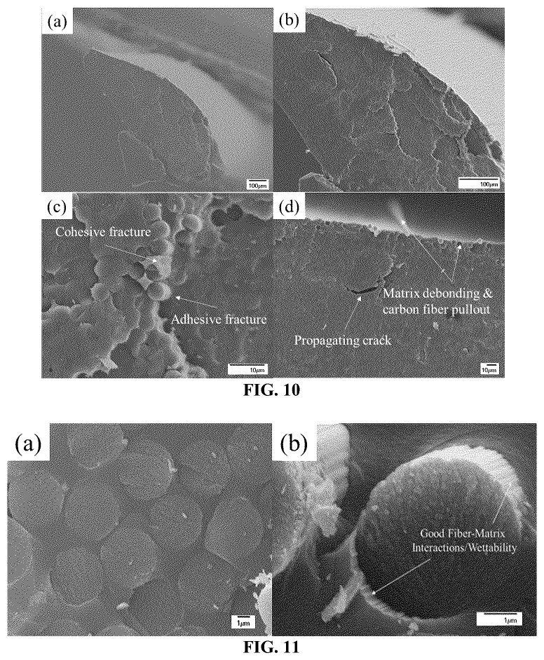

Besides the reactivity and viscosity profiles of the monomers, FIGS. 10-11 demonstrate the capability of B1-B3 in wetting the surface, filling the volume between the fibers, and penetrating the crevices/striations of the T300 carbon fiber. As can be observed from the micrographs, there are little to no voids within the matrix besides the fiber pullouts and fractures caused by breaking. This reaffirms the feasibility of impregnating the fiber preform with a pre-carbon matrix as a solid.

The results presented in this Example suggest a favorable fiber-matrix interaction. The surface adhesion is sure to be affected by the mechanical interlocking between the matrix and the striations on the fiber's surface. It has been found in several recent studies that the reactive aryl diradical intermediate produced from the Bergman cyclization of ODA monomers can directly graft to a variety of carbonaceous surfaces, including graphene, multi-walled fullerenes (carbon nanoonions, CNOs), and multi-walled carbon nanotubes (MWCNTs). It has not yet been determined if there are any chemical attachments at the fiber-matrix interface to accompany the mechanical locking in enhancing the surface adhesion. However, upon further carbonizations at higher temperatures (2000° C., 2500° C., etc) from a density standpoint, the significant amount of surface-area covered increases chances of interdigitation even after any possible shrinkage.

### Conclusions

C/C composites derived from BODA thermosetting polymer matrices have been made through an unoptimized cure schedule. Monomers B1-B3 exhibit carbon yields ranging from 71 and 83% without pressure or mechanical pressing. A one-step process for fabricating C/C composites is highly desirable and the BODA formulations presented herein may provide a feasible way to do so. The results presented herein show the successful fabrication of C/C composites using specialized carbon matrices made from BODA derived resins and attaining superior carbon yields than the current industrial standard (i.e., phenolic resins). Although the curing of the monomers and their synthesis has yet to be optimized, a simpler and more economical synthesis is being developed and cure kinetics with the MODA comonomers is being studied. Further study on the comparative mechanical properties of these ODA-derived C/C composites is necessary to prove this as a significant development in the matrix/materials chemistry of this class of composite. Since they outgas far lower volumes of condensates per wt. of solid produced and less of their original wt. fraction, it is likely the carbon matrix mechanical properties will be superior. Furthermore, other preliminary results suggest the aryl diradicals, produced by the cyclopolymerization, to be capable of grafting the pre-carbon matrix to the carbon-fiber reinforcement. This can not only enhance the interfacial strength of the composites described herein but also have more far-reaching applications for other classes of carbon-fiber composites. Another completely unknown frontier is the degree of void formation in ODA-based polymer matrices that are generated during their carbonization to glassy carbons and then into partially graphitized carbon, such studies are critical for the expansion of precursor materials to produce glassy carbon electrodes, catalysts, and more as well as C/C composites.

### Example 5

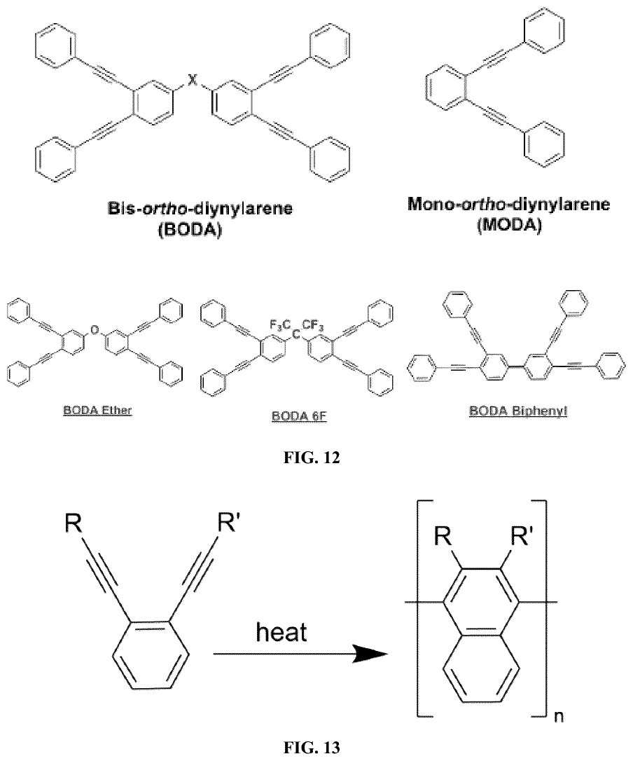

Mono-ortho-diynylarene (MODA) and bis-ortho-diynylarene (BODA) monomers are resin matrix precursors. The chemical structures for both MODA and BODA can be seen in FIG. 12. A variety of BODA monomers can be synthesized depending on the “X” linkages seen in FIG. 12. These monomers are used to prepare polyarylenes, a class of high-performance polymers that have many benefits such as thermal and oxidative stability, great chemical rigidity, and optical activity, through the Bergman cyclization mechanism. These polyarylenes are unique in that they contain acetylene groups which play a unique role in the polymerization mechanism. The materials produced from these precursors have the ability to be thermally stable at high temperatures and are moisture and solvent resistant. Another key feature of these polyarylenes is that they can have high carbon yields.

Theses high-performance polymers do, however, have some pitfalls such as poor melt and solution processability. To address these issues, the synthetic methodology developed by the present inventors uses thermally initiated Bergman cyclopolymerization, as seen in FIG. 13. Generally Bergman cyclization products yield linear systems of polyaromatics. However, further research led to these systems having a more complex structures, which are made up of complex copolymers. One benefit of this mechanism compared to that of phenolic resins is that curing is accomplished at high temperatures without any volatiles. Additionally, unlike other polyarylenes in the past, MODA and BODA are unique in that they have improved melt and solution processability, which makes these precursors very attractive for CCCs.

This Example describes the synthesis and copolymerization of MODA and BODA monomers, as well as uses thereof.

### Methods and Materials

### Materials

Chemical reagents and solvents were purchased from Sigma Aldrich purity ≥99% Oakridge. Chemical and were used as supplied without further purification unless otherwise stated. T300 carbon-fiber fabrics were supplied by Toray Carbon Fibers America, Inc.

### Nuclear Magnetic Resonance Spectroscopy (NMR)

All synthesized monomers were characterized using ¹H NMR and ¹³C NMR spectroscopy, using Bruker AVANCE III 300 and 500 MHz NMR instrument, monomers were all dissolved in deuterated chloroform. For monomers containing fluorine, ¹⁹F NMR was taken.

### Thermogravimetric Analysis (TGA)

This analysis was done using a (TA Instrument) Q50, to test the thermal stability of both the monomers and polymers. 4 to 8 mg of samples were heated from room temperature to 1000° C. under dry nitrogen and also compressed air at a constant heating rate of 3° C./min. The data obtained was analyzed using the TA universal analysis software and the plots were created using OriginPro.

### Differential Scanning Calorimetric (DSC)

DSC analysis was conducted using a (TA Instrument) Q200, at a rate of 3° C./min to a maximum temperature of 400° C. This analysis was done to study the thermal order-disorder events and to obtain any T_{g} or Tₘ of the homo-and co-polymers. The data obtained was analyzed using the TA universal analysis software and the plots were created using OriginPro.

### Fourier Transform Infrared Spectroscopy (FTIR)

FTIR was conducted using an Agilent Cary 630 spectrophotometer equipped with a diamond crystal ATR sample head.

### Results and Discussions

### MODA and BODA Monomer Synthesis

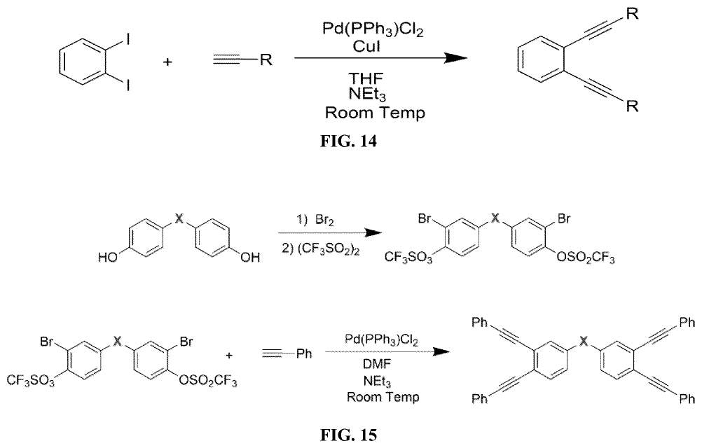

MODA and BODA monomers were synthesized by the following methods (FIGS. 14-15). BODA monomers were prepared from commercially available bisphenols and were purified using flash chromatography with silica. Monomers were characterized using ¹H NMR and ¹³C NMR. The synthesis of the BODA monomers follows a three-step process, bromination, triflation, and Sonagashira cross coupling, which is seen in FIG. 15.

### Synthesis of MODA

Synthesis of 1,2-bis(phenylethynyl)benzene—1.0 eq. of 1,2-diiodobenzene, 3.0 eq. of ethynylbenzene, 80 mL of tetrahydrofuran (THF), and 80 mL of trimethylamine were added to a 250 mL round bottom flask equipped with a magnetic stir bar. A rubber septum was then placed in the round bottom flask then taped down. The round bottom flask was then purged with argon for 15 minutes. In a separate 250 mL round bottom flask equipped with a magnetic stir bar was added 0.1 eq. of copper (I) iodide and 0.05 eq. of Pd(PPh₃)Cl₂. A rubber septum was then placed, and the round bottom was then purged with argon for 15 minutes. After both round bottom flasks was finished purging the first round bottom flask was transferred to the second round bottom flask (while argon was still flowing) using a cannula. After the transfer was complete the reaction was left stirring overnight at room temperature. After the reaction was complete, 50 mL of dichloromethane (DCM) was added and the mixture was washed with three 100 mL portions of 10% HCl solution, followed by one 100 mL wash with water. The organic layer was collected and evaporated using a Rotavap. The organic solution was purified by flash chromatography on silica using 5% DCM: hexane solution. ¹H NMR (300 MHz, CDCl₃): δ 7.30 (m, 6H), 7.15 (m, 8H) All other spectroscopic results agreed with the reported literature.

### Synthesis of BODA 6F

Synthesis of 2,2-Bis(3-bromo-4-hydroxyphenyl)-1,1,1,3,3,3-hexafluoropropane—To a 250 mL two neck round bottom flask equipped with a magnetic stir bar and a gas vent with calcium sulfate attached, was added 20 mL of glacial acetic acid (HOAc) and 120 mL of dichloromethane (DCM). 10 g (29.74 mmol) of 2,2-bis(4-hydroxyphenyl)-1,1,1,3,3,3-hexafluoropropane and 332.1 mg of iron powder (5.948 mmol) was added. 9.7 g of bromine was then added dropwise using an addition funnel. The reaction mixture was left running for 48 hr., after which it was washed with saturated aqueous sodium bicarbonate solution using a separatory funnel and twice with deionized water. The organic layer was dried over sodium sulfate, filtered, and evaporated providing 15.49 g of a yellow powder.

Synthesis of 2,2-Bis(3-bromo-4-trifluoromethanesulfonatophenyl)-1,1,1,-3,3,3-hexafluoropropane—The brominated bisphenol (15.49 g, 31.3 mmol) was dissolved in 10.5 mL of dichloromethane and 70.5 mL of dry triethylamine in a 150 mL round bottom flask equipped with a stir bar. The mixture was maintained between 8-12° C., as 22.1 g of trifluoromethanesulfonyl chloride which was dissolved in about 20 mL of dichloromethane was added. The mixture was stirred for 4 hr., after which the black solution was filtered out using a flash column with silica twice. The mixture was then washed using a separatory funnel two portions of aqueous 5% HCl (50 mL) and two portions of saturated sodium bicarbonate solution (50 mL) and lastly once with water. The organic layer was then dried over sodium sulfate, filtered, and evaporated to provide 10.92 g of colorless crystals. ¹H NMR (300 MHz, CDCl₃): δ 7.2 (4H, br, m), 7.43 (2H, s). All other spectroscopic results agreed with the reported literature.

Synthesis of 2,2-Bis(3,4-di(phenylethynyl)phenyl)-1,1,1,3,3,3-hexafluoropropane—To a single neck 150 mL round bottom flask equipped with a magnetic stir bar was added aryl dibromide ditriflate (5 g, 6.59 mmol) along with Pd(PPh₃)Cl₂ (462.5 mg, 0.659 mmol), the flask was then taped down and purged with argon for 15 minutes. In a separate single neck 150 mL round bottom flask equipped with a magnetic stir bar was added 25 mL of DMF and 25 mL of triethylamine and (4.03 g, 39.54 mmol) of phenylacetylene. The flask was then taped down and purged with argon for 15 minutes. Once the purging was complete the second flask containing all the solutions was transferred to the first flask using a cannula. After the transfer was complete the reaction was heated to 90° C. overnight. After the reaction was complete 50 mL of DCM was added and the mixture was washed with three portions of 10% HCl solution, followed by one 50 mL wash with water. The product was purified using column chromatography. ¹H NMR (300 MHz, CDCl₃): δ 7.31-7.43 (13H, br, m), 7.54-7.63 (13H, br, m) ¹³C NMR (300 MHz, CDCl₃): δ 87.43, 87.68, 94.74, 95.57, 122.94, 122.98, 126.36, 127.15, 128.55, 128.60, 128.91, 128.98, 131.83, 131.92, 131.93, 132.73, 133.34. ¹⁹F NMR (300 MHz, CDCl₃): δ-63.37 (s).

### Homo-Polymerization and Co-Polymerization

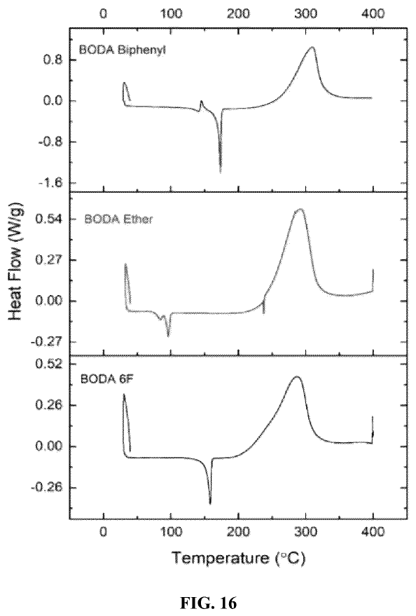

Homo- and co-polymerization studies of MODA and BODA monomers was achieved using differential scanning calorimetry (DSC). This was done by weighing out 3 to 5 mg of the monomers and placing it in a TA low-mass aluminum pan which was then sealed. Alongside the sample pan there was also a blank pan which was used as a reference. The sample was then subjected to a heat-cool-heat cycle (4 heating cycles, and 4 cooling cycles) at a rate of 3° C. per minute to 400° C. This same heating and cooling schedule was used for the co-polymerization studies. DSC gave insight into understanding a few important parameters such as melting temperature (Tₘ) and the temperature at which polymerization begins. FIG. 16 shows the first heating cycle for each of the BODA monomers.

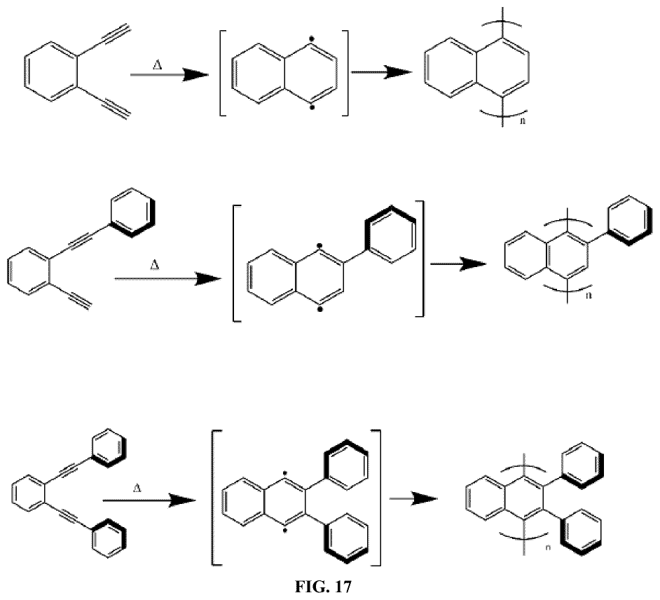

The same DSC study was performed for the MODA monomers, three different variants of the monomer were analyzed. FIG. 17 shows the three different MODA monomers undergoing the Bergman cyclization reaction. The DSC was conducted in the same manner as above, weighing a few milligrams into a TA low-mass aluminum pan which was then sealed. The sealed pan containing the monomer was placed alongside a blank pan into the DSC instrument. The sample was then subjected to a heat-cool-heat cycle (4 heating cycles, and 4 cooling cycles) at a rate of 3° C. per minute to 400° C.

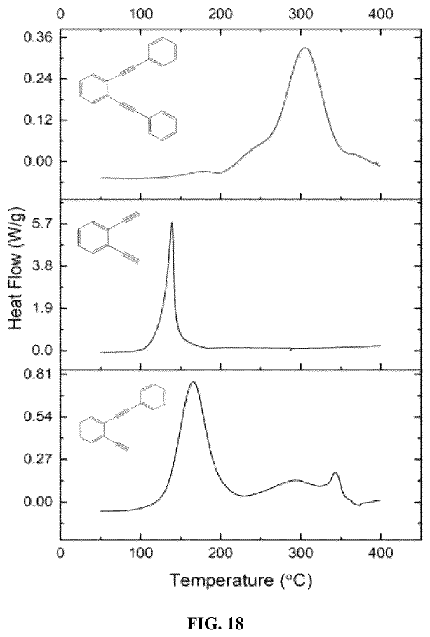

From the DSC thermogram graph in FIG. 16 the melting temperature for each of the BODA monomers can been seen along with the onset for the exotherm. This is detailed in Table 3. In the melt form the BODA monomers have an exothermic polymerization that begins at 200 to 220° C. Changing the “X” bridging group also affects the flexibility and overall processability of the resin during the polymerization. Comparing this data with the MODA monomers in Table 4 the exotherms are smaller. It is known that the trans alkyne distance between two ortho-diynes in the monomers has a significant effect on the activation energy of the Bergman cyclization. This is shown in Table 4 as the MODA substituent is varied and the trans alkyne distance is greater the activation energy also increases. Since MODA is already in a viscous melt form at room temperature, no Tm is observed. In the case of phenyl ethynyl benzene a second exotherm begins to appear around 300° C. very subtlety which is seen in the bottom thermogram graph in FIG. 18. From the thermogram graphs obtained, the melting point and the peak temperature of the exotherm were both obtained (Tables 3-4).

TABLE 3
Polymerization Events for BODA Monomers

| | | | | *Exotherm | | |
|---|---|---|---|---|---|---|
| | | | | −ΔH | | *Eₐ |
| | Tₘ | Tₑₓₒ | Exotherm | Reported | Eₐ | Reported |
| | peak | peak | −ΔH, | lit | (kJ/ | lit |
| Monomer | (° C.) | (° C.) | (kJ/mol) | (kJ/mol) | mol) | (kJ/mol) |
| BODA-6F | 165 | 287 | 389 | 457.6 | 115 | 121 |
| BODA- | 173 | 309 | 325 | 324.8 | 81 | |
| Biphenyl | | | | | | |
| BODA- | 95 | 290 | 483 | 483.3 | 121 | 129.7 |
| Ether | | | | | | |

Differential scanning calorimetry of BODA monomers at heating rate of (3° C./min) in nitrogen.
*Exotherms and Eₐ were obtained from Shah, H. V.; Babb, D. A.; Smith, D. W., Bergman cyclopolymerization kinetics of bis-ortho-diynylarenes to polynaphthalene networks. A comparison of calorimetric methods. Polymer 2000, 41 (12), 4415-4422.

TABLE 4
Polymerization Events of MODA Monomers

| | Tₑₓₒ peak | Exotherm −ΔH, | Eₐ |
|---|---|---|---|
| Monomer | (° C.) | (kJ/mol) | (kJ/mol) |
| Diethynyl-MODA | 139 | 117 | 57 |
| Phenyl ethynyl-MODA | 166 | 159 | 80 |
| Biphenyl-MODA | 305 | 343 | 172 |

Differential scanning calorimetry of MODA monomers at heating rate of (3° C./min) in nitrogen.

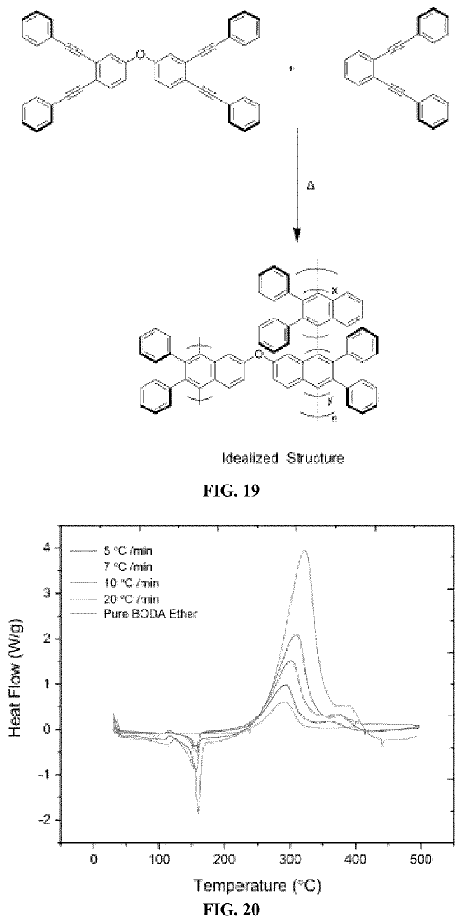

After examining the homo-polymerization of both MODA and BODA monomers the co-polymerization of biphenyl MODA and BODA ether was studied using DSC in the same manner. FIG. 19 shows the heat-initiated co-polymerization occurring in the DSC and the resulting idealized structure is shown.

The co-polymerization of biphenyl MODA and BODA ether at a 1:2 ratio is seen in FIG. 20. This DSC was taken at varying heating rates along with the pure BODA ether for comparison. The purpose of this experiment is to see the effect that MODA has on the onset of polymerization. The melting temperature, along with the exotherm onset and the enthalpy are recorded in Table 5. This study shows that when MODA is added as a co-monomer the melting and exotherm values are all shifted to higher values meaning that MODA extends the onset of polymerization thereby expanding the processability window. This is seen in Table 5 especially when compared to the pure BODA ether, the co-polymerizations have higher melting temperatures as well as enthalpy values. Although the melting temperatures and exotherm peaks all increased compared to the pure BODA ether, the enthalpy values did not have much change.

TABLE 5
Polymerization Events of 1:2 MODA to BODA Co-Polymerization

| | Heating rate | Tₘ peak | Tₑₓₒ peak | Exotherm −ΔH, |
|---|---|---|---|---|
| Entry | (° C./min) | (° C.) | (° C.) | (kJ/mol) |
| BODA Ether | 3 | 96 | 290 | 483 |
| 1:2 MODA to | 5 | 157 | 294 | 438 |
| BODA Ether | 7 | 158 | 303 | 438 |
| | 10 | 157 | 310 | 469 |
| | 20 | 160 | 322 | 475 |

Co-polymerization DSC study at varying heating rates

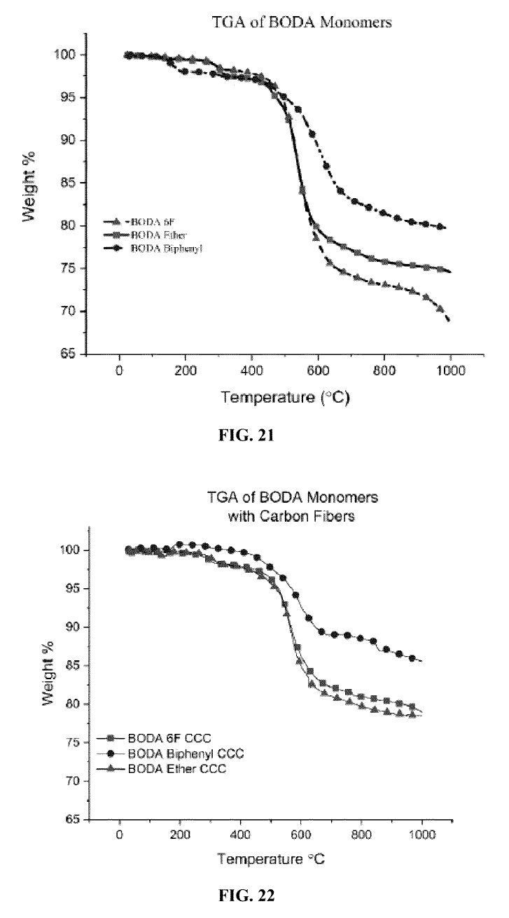

It is important to understand the thermal stability of these monomers, and for this purpose, thermogravimetric analysis (TGA) was conducted. FIG. 21 shows the TGA results for the BODA monomers conducted in nitrogen. This experiment was then repeated incorporating carbon fiber and the thermograph is shown in FIG. 22.

The TGA in FIG. 21 shows that the BODA monomers are stable to about 450° C. without much weight loss. BODA biphenyl had an initial drop in weight percent compared to the other two samples and this can be attributed to the sample containing trace amounts of solvent or impurities. The carbonized products appeared glass like, this is a characteristic that is highly sought after for high thermal, oxidative, and high-performance properties. Minimal weight loss was seen with the pure samples, the experiment was repeated using T300 carbon fiber in the hopes that the weight loss would be decreased and to have an idea of how the BODA samples withstand high temperatures with the incorporation of carbon fiber. FIG. 22 shows the TGA result with carbon fiber.

In the second experiment it shows that the addition of the carbon fiber with the BODA monomers gave a much higher weight percent than compared with the original TGA of just the monomers. As seen in FIG. 22 with the addition of carbon fiber the lowest wight percent was around 78%. Since carbon fiber is already very thermally stable it is expected to have good thermal stability when incorporated with the BODA monomers. In each experiment the sudden decrease in percent weight around 500° C. shows that the carbonization process is taking place. This shows that the BODA monomers can withstand extreme temperatures and still maintain a respectable percent weight loss, and the addition of carbon fiber helps minimize the percent weight loss.

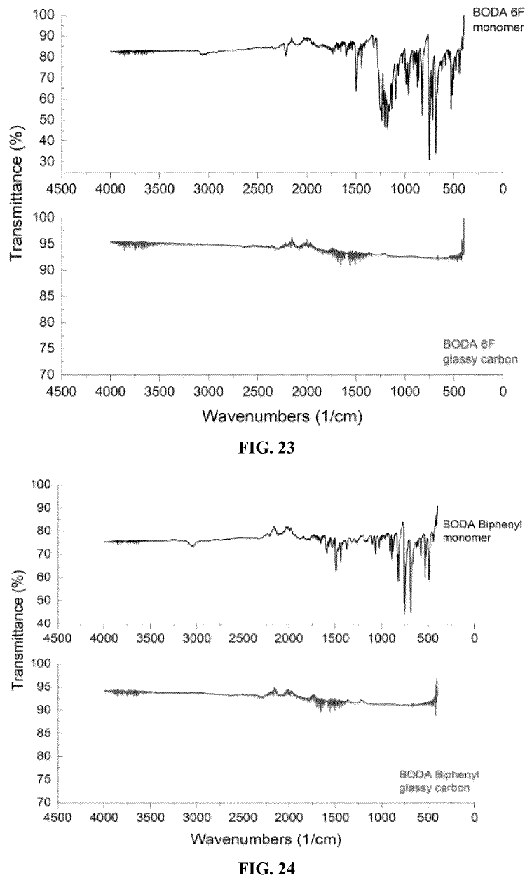

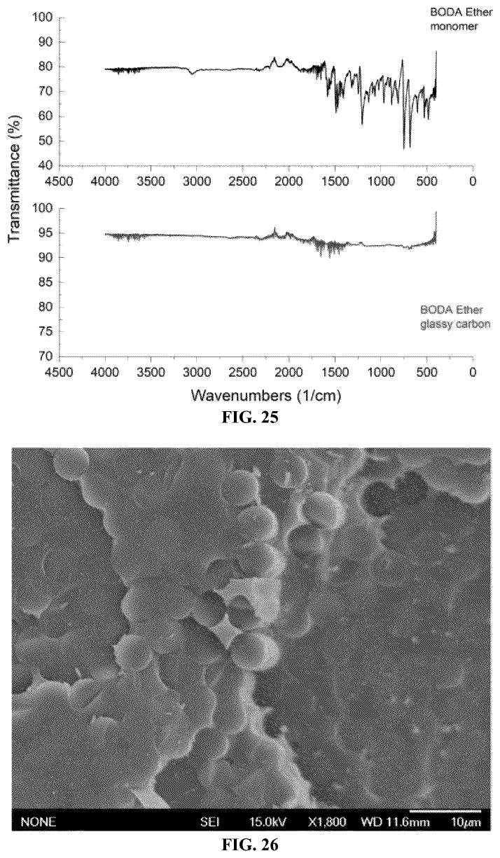

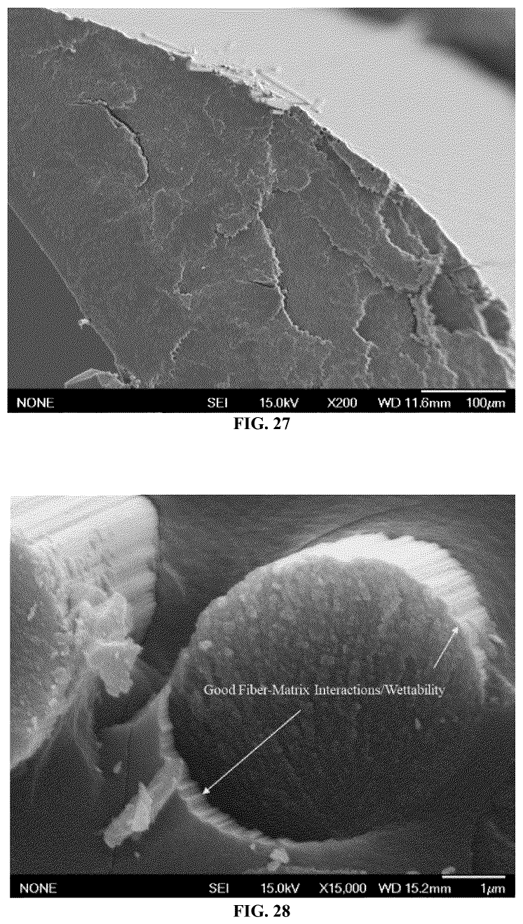

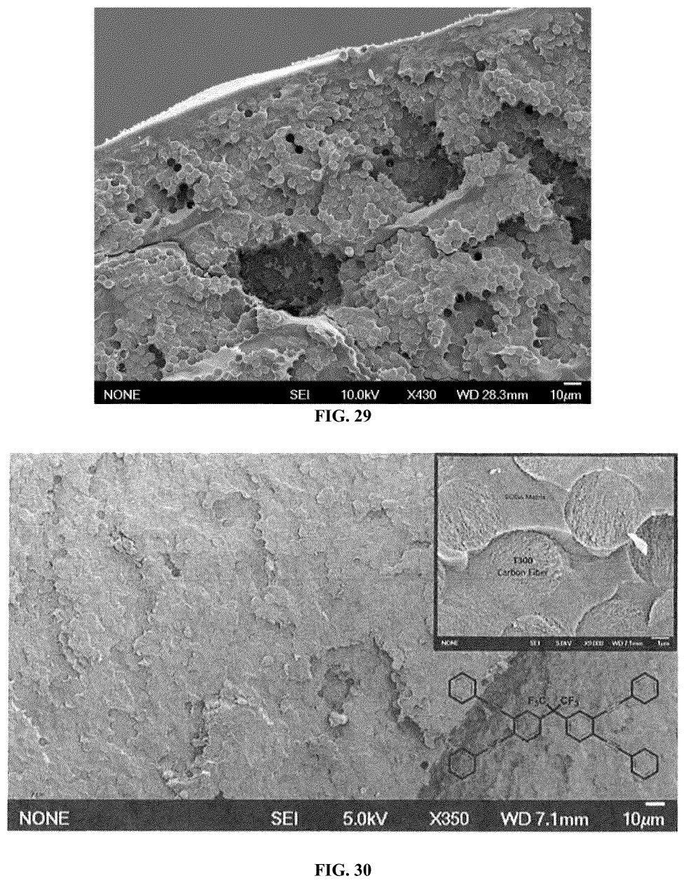

Further investigation at how these monomers carbonize in the presence of carbon fiber lead to making small composites for further analysis. Following a composite cure schedule each sample was cured then carbonized. Infrared spectroscopy was taken of the pure sample, and once again after it has been carbonized. For each carbonized sample imaging was taken using a scanning electron microscope (SEM) to have a better understanding of the surface morphology of the samples. In order to conduct this experiment, the samples were prepared in ceramic boats. A layer of the monomer was first evenly laid down followed by a layer of T300 carbon fiber followed by another layer of monomer which evenly covered the carbon fiber layer. The ceramic boat was then placed inside a quartz tube which was placed inside a furnace capable of reaching 1500° C. At the end of the experiment SEM images were taken of each carbonized sample as well as infrared spectroscopy. FIGS. 23-25 show the infrared spectra of the pure monomer and the spectra after the sample has been carbonized. Once the material has been carbonized at 1000° C. the morphology of the surface was analyzed using SEM (FIGS. 26-27). Higher temperature above 1000° C. was also sampled and FIGS. 28-29 show BODA composites that were taken up to 1500° C.

The infrared spectrum shown in FIG. 23 of the BODA 6F monomer is compared to the carbonized composite and as expected the carbonized composite shows much of the infrared vibration minimized compared to the noncarbonized monomer. This is showing that the carbonization is forming a complete polymer network and once it reaches high enough temperatures it takes on the form of glassy carbon. One common stretching frequency that is seen in all three of the BODA monomers is the phenyl wagging vibration which appears near 754 cm⁻¹ this stretching frequency can be seen in the IR for the pure monomers, then disappears for each of the carbonized samples, suggesting that the polymer network has formed and that phenyl wagging vibration is no longer observed.

The carbonization of BODA ether monomers at 1000° C. shown in FIGS. 26-27 is examined using SEM. As depicted in FIG. 26 the fiber and the matrix has good interaction and minimal voids, there was also no signs of propagating cracks that were observed. Looking at FIG. 27 it shows how well the carbon fibers are held together by the matrix, no major cracks or voids are observed. FIGS. 26-27 conclude that the composite is very stable at 1000° C. Looking at FIGS. 28-29 this shows BODA ether composites that has been heated to 1500° C. Starting with FIG. 28 this shows a single fiber and how it interacts with the matrix, it also shows good wettability and the detail of the striation of the fiber is seen embedded in the matrix. In a zoomed out version shown in FIG. 29 the composite at 1500° C. shows no major cracks or voids.

### Conclusions

To understand the polymerization events with mono-ortho-diynylarene (MODA) and bis-ortho-diynylarene (BODA) monomers differential scanning calorimetric was utilized. The DSC shows that co-polymerizing MODA and BODA extends the onset of polymerization and in return expands the processability window, as compared to BODA alone. Additionally, to better understand the thermal stability at high temperatures thermogravimetric analysis was used. The TGA shows that these monomers are stable at high temperatures with very little weight loss. Incorporating carbon fiber with BODA monomers was also examined to understand the thermal stability and how the fiber interacts with the BODA monomers. The result shows the addition of carbon fiber with the BODA monomers resulted in an increase of weight percent. The surface morphology which is important to carbon composites was also examined using SEM imaging. The results showed minimal cracks and no voids which is key for composites to perform well at high temperatures, which are characteristics that are highly sought after in applications such carbon-carbon composites and devices.

Based upon these results the MODA and BODA monomers show promising potential to take advantage of synthetic chemistry and achieve thermal stability while offering improved processability and high-performance. The MODA and BODA approach to making carbon composites is unique in that their polymerization is heat initiated. The use of this unique synthetic chemistry facilitates preparation of polymer pre-networks that are thermally stable and are provide high-performance. Unique synthetic approaches such as this are highly sought, mainly due to the properties that are improved such as thermal stability at high temperatures which ultimately yields in high performance materials. Furthermore, these monomers can be produced at large scales and can be cured to high temperatures.

### Example 6

Although much has been published on BODA derived polymers and carbon structures upon pyrolysis, it is believed that the use of these precursors to produce CCCs is unknown. This Example describes the production of a CCC from BODA monomers.

Demonstrated herein are the first BODA/CCC structures. BODA monomers were first formed from bis-phenols through a three step process involving Br₂, CF₃SO₂Cl, and [Pd]/PhCCH. The resulting BODA monomers were then thermally cyclopolymerized at 200° C. through catalyst- and initiator-free thermal step-growth addition polymerization to form a resin intermediate void of condensation products or mobile impurities. Next, the resin intermediate was thermally processed at 450° C. to form a polynaphthalene network, which was then cured at 1000° C. for 2 hours to form a glassy carbon. A complex viscosity was observed during cure (210° C.) of BODA monomers with variable X spacer, and a large monomer melt window was provided prior to gelation. Referring to FIG. 30, after processing and carbonization, unprecedented long range cross section fracture surfaces were completely free of voids and fiber/matrix interface delamination.

### Example 7

This example demonstrates a fast carbonization rate without affecting the quality of the final carbon.

Specifically, as shown herein, BODA materials B1-B3 cure without the formation of any volatile condensates, and have a high initial carbon composition. The present inventors have also shown the effect of the cure and following carbonization ramp rates of the BODA-derived resins on their final glassy carbon properties.

Neat carbon samples for the this example were prepared from the same neat BDR after having been cured at 400° C. slowly (1° C./min). Furthermore, size (20 mg), nitrogen flow rate (10° C./min) and cooling rate (5° C./min) were kept constant throughout each sample-only changing the carbonization heating rate.

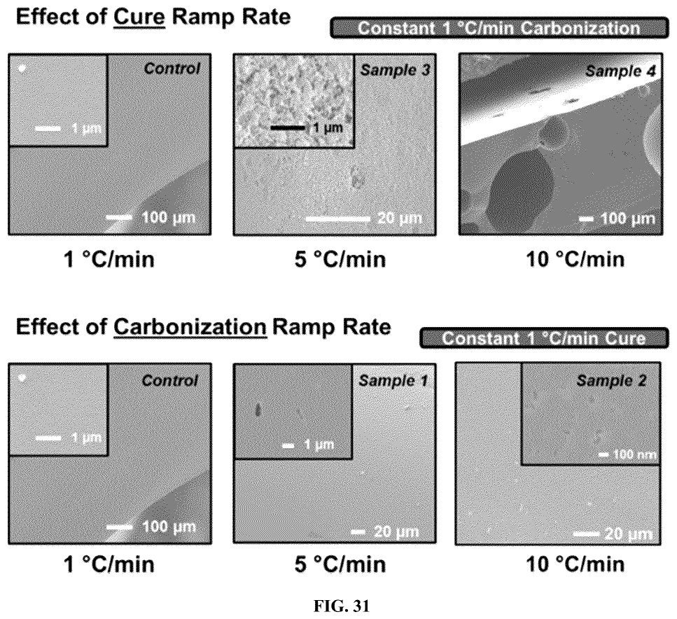

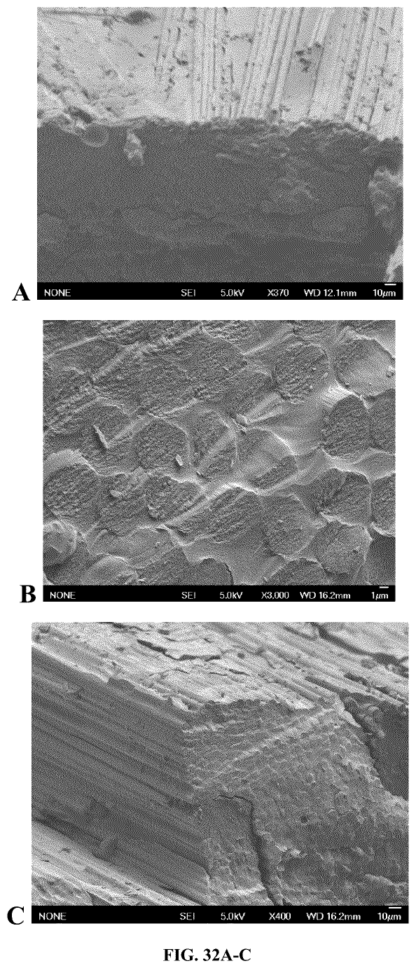

A glassy carbon control sample was prepared by slowly curing and carbonizing BODA Biphenyl (B3) at a rate of 1° C./min. Then its density and degree of crystallinity (ID/IG) was measured. To show the isolated effects of the rate of cure and carbonization, only one ramp rate was changed at a time. For example, the cure ramp rate was held at 1° C./min while the carbonization ramp rate was increased to 5 and 10° C./min (Table 6, Sample 1 and 2). When the carbonization rate was increased to 5° C./min and the cure rate held at 1° C./min, the ID/IG value remained the same while a lower density was achieved relative to the control. A drop in both ID/IG and density was observed when the carbonization was held at 1° C./min and the cure ramp rate increased to 5 and 10° C./min (Table 6). This indicated that the rate of carbonization has a smaller impact on the final carbon properties than the rate of cure. Therefore, carbonization of BODA derived resins are possible at higher ramp rates than those fabrication schedules typically prescribed today without significantly compromising the quality of the final carbon. This is further demonstrated by the micrographs shown in FIG. 31 and FIG. 32. As the cure ramp rate is increased against a constant carbonization ramp rate (1° C./min), the SEM cross sections of the carbon microstructure are visibly changed. However, in agreement with the density and ID/IG measurements, when the carbonization ramp rate is increased against a constant cure ramp rate (1° C./min) the carbon micrographs remain relatively unchanged. The SEM images here are largely representative of multiple micrographs taken for each sample at the size scale wherein the first carbon surface features can be observed, if any (e.g. voids, debris from fracture, porosity, etc.). Unsurprisingly, due to the relatively low mass loss upon carbonization in B3 there is no significant porosity generated when the ramp rate at this stage is increased (1, 5, and 10° C./min).

Upon curing from 30 to 400° C., sample 2 (cured at 1° C./min, see Table 6, below) shows a rough surface with essentially no pores or void areas that can be observed using an optical microscope up to ×50 magnification. However, upon curing, sample 4 (cured 10° C./min) shows a range of different pore sizes: large (100-200 um), medium (averaging ˜12±3 μm), and smaller pores >1 μm. These trapped voids remain in the structure even if carbonized slowly. If they are never produced (via slow cure) then a fast carbonization will do little to generate additional porosity. As commonly understood, a slow cure allows the polymer to organize, stack, and template phase growth that yields a carbon with a higher degree of crystallinity and high density, as indicated by the corresponding ID/IG values.

The results shown here are different from those expected from phenolic-derived carbon, where fast carbonization ramp rates are typically detrimental to carbon properties and performance. This implies that the BODA approach provides much faster processing times for carbon than those derived from phenol-formaldehyde. This is advantageous at least because first, fewer reinfusions are required using BODA-derived resins. Secondly, the BODA materials have a capacity to be carbonized at much faster carbonization rates without impeding the carbon quality (i.e. uniformity, density, porosity, crystallinity, etc.).

TABLE 6
Effect of B3 cure (to 400° C.) & carbonization (400-1000° C.)
rate on carbon density and crystallinity.

| | Cure rate (° C./ | Carbonization | Density (g/ | |
|---|---|---|---|---|
| Sample | min) | Rate (° C./min) | mL) | I_{D}/I_{G} |
| Control | 1 | 1 | 1.5 ± 0.01 | 1.12 ± 0.01 |
| 1 | 1 | 5 | 1.46 ± 0.01 | 1.12 ± 0.01 |
| 2 | 1 | 10 | 1.49 ± 0.01 | 1.15 ± 0.01 |
| 3 | 5 | 1 | 1.43 ± 0.01 | 1.19 ± 0.01 |
| 4 | 10 | 1 | 1.31 ± 0.01 | 1.21 ± 0.01 |

As can be seen from FIG. 33, a heating rate of 100° C./min is required before noticeable surface features are observed different from those prepared at a typical, slow heating rate (1° C./min). Furthermore, the resulting crystallinity of the neat carbon samples all seem to be within error when studied as a function of carbonization heating rate, even when going as high as 100° C./min (FIG. 33). This result has been reproduced in three different sample sets from BDR and greatly exceeds the results obtained from similar studies published on other high carbon yield resins.

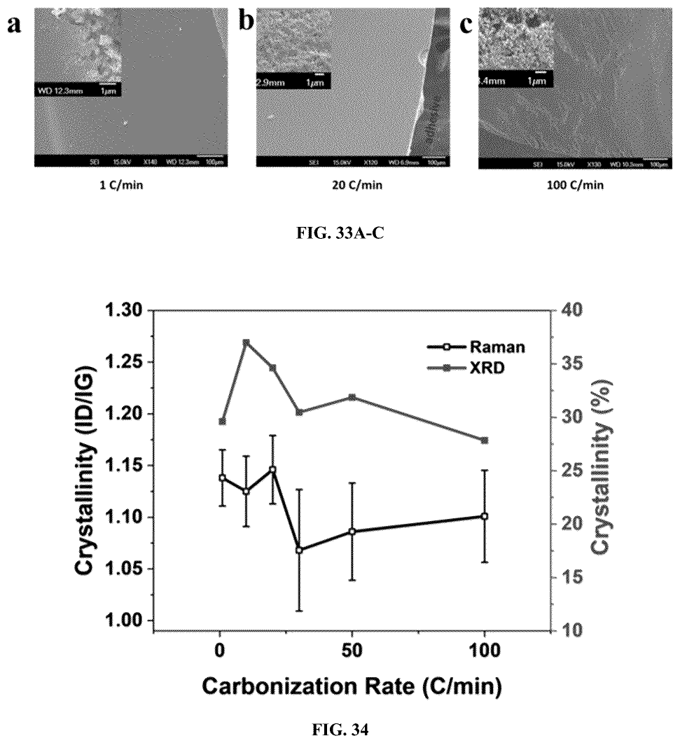

The conclusion of the cure and carbonization rate studies shown in this example is illustrated in FIG. 34. Raman and XRD data indicates clearly that fast carbonization rates do not decrease crystallinity. Therefore, the most important metrics of char yield, density, and crystallinity are not negatively affected by fast carbonization rates for BDR resin.

The C/C community by large has mostly given up on trying to save processing time with fast carbonization heating rates because of the poor results obtained (due to cracks, pores, voids, and internal stresses generated) from fast heating rates. However, due to the high carbon yield of the BDR system, and its low dimensional shrinkage going from thermoset to carbon, there is an opportunity to process C/C composites from BDR at unprecedented rates. The data of this example indicate that fast carbonization rates do little to generate porosity in neat carbon samples obtained from BDR alone.

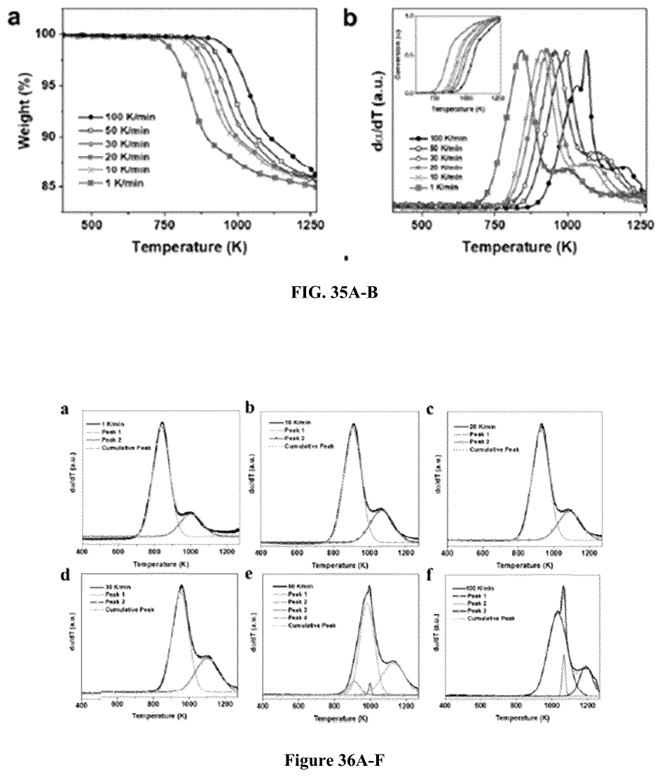

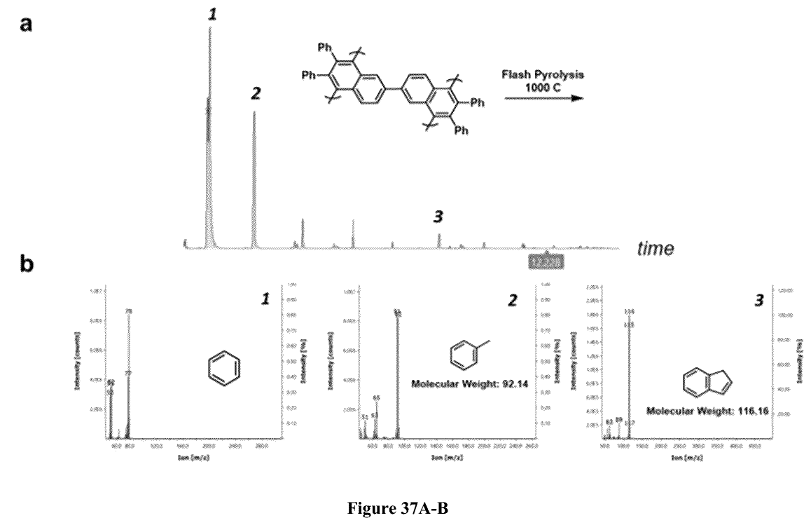

The non-oxidative pyrolysis of BDR is shown in FIG. 35-36, at variable carbonization rates (1, 10, 20, 30, 50, 100 K/min). Roughly the same char yield is obtained after achieving an internal temperature of 1000° C. (84%). Slightly higher char yields are measured at higher carbonization heating rates due to temperature difference between the sample and the thermal couple, which likewise results in a perceived enhancement of thermal stability or shifting of the onset of degradation temperature. Clearly, there is no decrease in carbon yield due to the fast carbonization rate. Conversion was extrapolated from each TGA curve and a plot of conversion as a function of temperature is obtained. The derivative plot of conversion with respect to temperature can be obtained and reveals a major peak with gaussian character and a distinct shoulder at higher temperatures (FIG. 5A(b). A peak deconvolution of this derivative plot reveals gaussian distributions for each of the major degradation mechanisms that are occurring. In agreement with the SEM, Raman, and XRD data, the same degradation profile seems to insist even at very fast heating rates and doesn't seem to change until an intermediate peak becomes apparent at 50 K/min and then more prominently at 100 K/min (FIG. 6A).

Furthermore, there are additional opportunities with BDRs beyond fast carbonization heating rates. Typically, production of a C/C composite part is done such that the cure, carbonization, and graphitization are carried out as separate processes. The carbonization (˜1000° C.) and graphitization (˜2000° C. and beyond) are done separately because of the significant off gassing that occurs in other lower carbon yield resins. Straight to graphitization from a polymer matrix composite (PMC) is avoided in industry because the current resin technology will harmfully degrade and even destroy these valuable, high temperature furnaces due to the significant generation of oxidizing/flammable volatiles in their initial carbonization.

To illustrate the low evolution of problematic off-gassing during cure and carbonization, a mass spectra of the volatiles generated during the flash pyrolysis of our BDR (FIG. 7) reveals the off gassed products to be non-oxidizing aromatic hydrocarbons. In addition, the overall unprecedented yield from starting resin (80+%) to finished carbon-carbon composite part or ceramic hybrid. This data strongly suggests the BDR is a high contender for a straight to graphitization fabrication process as the observable volatiles are not generated in significant amounts and do not auto-ignite under inert atmosphere.

The BDR system already achieves CCC densities of 1.57 g/mL after its first infusion/densification at 1000° C. This density is equivalent to that obtained from 4 infusion/densification cycles obtained using the current industrial standard (phenolic resins). The lowered reinfusion cycles coupled with fast carbonization heating rates (as opposed to the ˜1° C./hr process currently used due to delamination issues) and potential to go straight to graphitization from our PMCs, offers the potential to change the current lead times of 6-9 months of a CCC down to possibly weeks.

Accordingly, one embodiment of the present invention is a polymer processed with or without comonomers and with an inert atmosphere with carbon fiber in two steps comprising (1) network formation or cure by heating or curing to 400° C. at a specified rate and (2) carbonization to 1000° C. or higher at a specified rate.

All publications, patents, and patent applications mentioned in this specification are herein incorporated by reference to the same extent as if each individual publication, patent, or patent application was specifically and individually indicated to be incorporated by reference, including the references set forth in the following list:

### REFERENCES

1. U.S. Patent Application Publication No. 2023/0098530.
2. D.L.; Chung, “Carbon Fiber Composites”. 1^{st} ed. London: Butterworth-Heinemann, 2012.
3. Raunija, Thakur Sudesh Kumar, et al. “Preparation and Process Optimization of Randomly Oriented C/C Composites by a Novel Method.” New Carbon Materials 2018, 33(5), 423.
4. Smith, Jr., Dennis W., et al. “Polynaphthalene Networks from Bisphenols.” Journal of the American Chemical Society. 1998, 120(35), 9078.
5. Smith Jr., D. W., et al. “Polyarylene Networks Via Bergman Cyclopolymerization of Bis-Ortho-Diynyl Arenes.” Advanced Functional Materials 2007, 17, 1237.
6. Shah, H. V., et al. “Bis-O-Diynylarene (Boda) Derived Polynaphthalenes as Precursors to Glassy Carbon Microstructures.” Chemistry of Materials 1999, 11(10), 2623-2625.
7. Economy, J., H. Jung, and T. Gogeva. “A One-Step Process for Fabrication of Carbon-Carbon Composites.” Carbon 30.1 (1992)
8. Hay, Allan. “Communications-Oxidative Coupling of Acetylenes.” The Journal of Organic Chemistry 25.7 (1960)
9. Neenan, Thomas X., and George M. Whitesides. “Synthesis of High Carbon Materials from Acetylenic Precursors. Preparation of Aromatic Monomers Bearing Multiple Ethynyl Groups.” The Journal of Organic Chemistry 53.11 (1988).
10. Bergman, Robert G. “Reactive 1,4-Dehydroaromatics.” Accounts of Chemical Research 6.1 (1973)
11. John, Jens A., and James M. Tour. “Synthesis of Polyphenylenes and Polynaphthalenes by Thermolysis of Enediynes and Dialkynylbenzenes.” Journal of the American Chemical Society 116.11 (1994).
12. S.B. Sastri, T.M. Keller, T.M. Jones, and J.P. Armistead. “Studies on Cure Chemistry of New Acetylenic Resins”. Vol. 26, 23, 6171-6174. Macromolecules, 1993. [https://doi.org/10.1021/ma00075a005]
13. Rettenbacher, A.S.; Perpall, M.W.; Echegoyen, L.; Smith, D.W., Jr., “Radical Addition of a Conjugated Polymer to Multilayer Fullerenes (Carbon Nano-onions)” Chem. Mater. 2007, 19, 1411-1417.
14. Chung, D. D. L., 7—Carbon-Matrix Composites. In Carbon Composites (Second Edition), Butterworth-Heinemann: 2017; pp 387-466.
15. Sheehan, J. E., Oxidation protection for carbon fiber composites. Carbon 1989, 27(5), 709-715.
16. Kim, J. I.; Kim, W. J.; Choi, D. J.; Park, J. Y.; Ryu, W. S., Design of a C/SiC functionally graded coating for the oxidation protection of C/C composites. Carbon 2005, 43(8), 1749-1757.
17. Sheehan, J. E.; Strife, J. R., Ceramic Coatings for Carbon-Carbon Composites. American Ceramic Society Bulletin 1988, 67(2), 369-374.
18. Cairo, C. A. A.; Graça, M. L. A.; Silva, C. R. M.; Bressiani, J. C., Functionally gradient ceramic coating for carbon-carbon antioxidation protection. Journal of the European Ceramic Society 2001, 21(3), 325-329.
19. Zhu, Y.-C.; Ohtani, S.; Sato, Y.; Iwamoto, N., Formation of a functionally gradient (Si3N4+SiC)/C layer for the oxidation protection of carbon-carbon composites. Carbon 1999, 37(9), 1417-1423.
20. Gee, S. M.; Little, J. A., Oxidation behaviour and protection of carbon/carbon composites. Journal of Materials Science 1991, 26(4), 1093-1100.
21. Goto, K. S.; Han, K. H.; Pierre, G. R. S., A Review on Oxidation Kinetics of Carbon Fiber/Carbon Matrix Composites at High Temperature. Transactions of the Iron and Steel Institute of Japan 1986, 26(7), 597-603.
22. Halbig, M. C.; McGuffin-Cawley, J. D.; Eckel, A. J.; Brewer, D. N., Oxidation Kinetics and Stress Effects for the Oxidation of Continuous Carbon Fibers within a Microcracked C/SiC Ceramic Matrix Composite. Journal of the American Ceramic Society 2008, 91 (2), 519-526.
23. Wang, X; Schmidt, F.; Hanaor, D. et al. “AM of Ceramics from Preceramic Polymers” Additive Manufacturing 2019, vol. 27 pp 80-90.
24. Bucca, D.; Keller, T. M., Oxidation-resistant thermosets derived from thermal copolymerization of acetylenic monomers containing boron and silicon. Journal of Polymer Science Part A: Polymer Chemistry 1999, 37(23), 4356-4359.
25. Chung, D.D.L., 7-Carbon-Matrix Composites, in Carbon Composites (Second Edition). 2017, Butterworth-Heinemann. p. 387-466.
26. Economy, J., H. Jung, and T. Gogeva, A one-step process for fabrication of carbon-carbon composites. Carbon, 1992. 30(1): p. 81-85.
27. Raunija, T.S.K., et al., Preparation and process optimization of randomly oriented C/C composites by a novel method. New Carbon Materials, 2018. 33(5): p. 423-433.
28. Smith, D.W., et al., Polynaphthalene Networks from Bisphenols. Journal of the American Chemical Society, 1998. 120(35): p. 9078-9079.
29. Smith Jr., D.W., et al., Polyarylene Networks via Bergman Cyclopolymerization of Bis-ortho-diynyl Arenes. Advanced Functional Materials, 2007. 17(8): p. 1237-1246.
30. Martin, S.J., et al., Development of a Low-Dielectric-Constant Polymer for the Fabrication of Integrated Circuit Interconnect. Advanced Materials, 2000. 12(23): p. 1769-1778.
31. Shah, H.V., et al., Bis-o-diynylarene (BODA) Derived Polynaphthalenes as Precursors to Glassy Carbon Microstructures. Chemistry of Materials, 1999. 11(10): p. 2623-2625.
32. Zengin, H. and D.W. Smith, Bis-ortho-diynylarene polymerization as a route to solid and hollow carbon fibers. Journal of Materials Science, 2007. 42(12): p. 4344-4349.
33. Perpall, M.W., et al., Novel Network Polymer for Templated Carbon Photonic Crystal Structures. Langmuir, 2003. 19(18): p. 7153-7156.
34. Yang, X., et al., Synthesis of Ultrathin Mesoporous Carbon through Bergman Cyclization of Enediyne Self-Assembled Monolayers in SBA-15. Langmuir, 2010. 26 (13): p. 11244-11248.
35. Iacono, S.T., et al., Carbonization and thermal expansion of glassy carbon derived from bis-ortho-diynylarenes. Carbon, 2007. 45 (5): p. 931-935.
36. Hay, A., Communications—Oxidative Coupling of Acetylenes. The Journal of Organic Chemistry, 1960. 25 (7): p. 1275-1276.
37. Neenan, T.X. and G.M. Whitesides, Synthesis of high carbon materials from acetylenic precursors. Preparation of aromatic monomers bearing multiple ethynyl groups. The Journal of Organic Chemistry, 1988. 53 (11): p. 2489-2496.
38. Bergman, R.G., Reactive 1,4-dehydroaromatics. Accounts of Chemical Research, 1973. 6(1): p. 25-31.
39. John, J.A. and J.M. Tour, Synthesis of Polyphenylenes and Polynaphthalenes by Thermolysis of Enediynes and Dialkynylbenzenes. Journal of the American Chemical Society, 1994. 116(11): p. 5011-5012.
40. Sastri, S.B., et al., Studies on cure chemistry of new acetylenic resins. Macromolecules, 1993. 26(23): p. 6171-6174.
41. Rule, J.D., S.R. Wilson, and J.S. Moore, Radical Polymerization Initiated by Bergman Cyclization. Journal of the American Chemical Society, 2003. 125(43): p. 12992-12993.
42. Gerstel, P. and C. Barner-Kowollik, RAFT Mediated Polymerization of Methyl Methacrylate Initiated by Bergman Cyclization: Access to High Molecular Weight Narrow Polydispersity Polymers. Macromolecular Rapid Communications, 2011. 32(5): p. 444-450.
43. Zhu, B., et al., Formation of polymeric nanoparticles via Bergman cyclization mediated intramolecular chain collapse. Journal of Materials Chemistry, 2011. 21(8): p. 2679-2683.
44. Cheng, X., et al., Synthesis of Novel “Rod-Coil” Brush Polymers with Conjugated Backbones through Bergman Cyclization. Macromolecules, 2010. 43(2): p. 909-913.
45. Sun, Q., et al., On-Surface Formation of One-Dimensional Polyphenylene through Bergman Cyclization. Journal of the American Chemical Society, 2013. 135(23): p. 8448-8451.
46. Wang, Y., S. Chen, and A. Hu, Construction of Polyarylenes with Various Structural Features via Bergman Cyclization Polymerization. Top Curr Chem (Cham), 2017. 375(3): p. 60.
47. Xiao, Y. and A. Hu, Bergman Cyclization in Polymer Chemistry and Material Science. Macromolecular Rapid Communications, 2011. 32(21): p. 1688-1698.
48. Ma, X., et al., Functionalization of Pristine Graphene with Conjugated Polymers through Diradical Addition and Propagation. Chemistry—An Asian Journal, 2012. 7(11): p. 2547-2550.
49. Rettenbacher, A.S., et al., Radical Addition of a Conjugated Polymer to Multilayer Fullerenes (Carbon Nano-onions). Chemistry of Materials, 2007. 19(6): p. 1411-1417.
50. Ma, J., et al., Functionalization of multiwalled carbon nanotubes with polyesters via bergman cyclization and “grafting from” strategy. Journal of Polymer Science Part A: Polymer Chemistry, 2010. 48(23): p. 5541-5548.
51. Ma, J., et al., Covalent surface functionalization of multiwalled carbon nanotubes through bergman cyclization of enediyne-containing dendrimers. Journal of Polymer Science Part A: Polymer Chemistry, 2011. 49(18): p. 3951-3959.

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A polymer resin comprising:
at least one bis-o-diynylarene (BODA) monomer, including a structure according to Formula I: 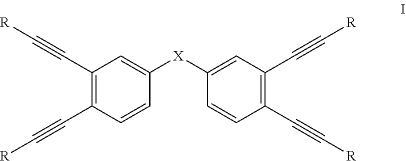
wherein X includes O, C(CF₃)₂, or a bond; and
wherein each R independently includes H, alkyl, alcohol, trimethylsilyl, aryl, or a substituted version thereof; and
wherein the resin is processable at a temperature of less than 200° C.;
processed with or without co-monomers and with an inert atmosphere with carbon fiber in two steps comprising (1) network formation or cure by heating or curing to 400° C. at a specified rate and (2) carbonization to 1000°° C. or higher at a specified rate.

2. The polymer resin of claim 1, wherein X is a bond.

3. The polymer resin of claim 1, wherein the cure (step 1) heating rate is 1-10° C./min, preferably 1° C./min.

4. The polymer resin of claim 1, wherein the carbonization (step 2) heating rate is 10-50° C./min or higher.

5. The polymer resin of claim 1, wherein carbon fiber is at least 50% (vol) of the resulting carbon-carbon composite structure after complete carbonization.

6. A method of making a carbon-carbon composite (CCC), comprising:
providing at least one bis-o-diynylarene (BODA) monomer;
providing carbon fiber;
forming a network by (1) heating or curing to 400° C. and (2) carbonizing to 1000° C. or higher.

7. The method of claim 6, wherein the curing ramp rate is about 1° C./min and the carbonization ramp rate is higher than the curing ramp rate.

8. The method of claim 7, wherein the carbonization ramp rate is about 5-10° C./min.

9. The method of claim 6, wherein the CCC is processed in an inert atmosphere.

10. The method of claim 6, wherein the CCC is processed without co-monomers.

11. The method of claim 6, wherein at least one bis-o-diynylarene (BODA) monomer is including a structure according to Formula I: 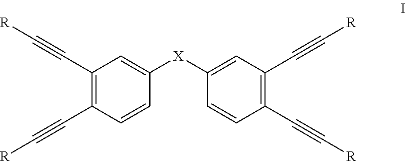
wherein X includes O, C(CF₃)₂, or a bond; and
wherein each R independently includes H, alkyl, alcohol, trimethylsilyl, aryl, or a substituted version thereof.

12. The method of claim 11, wherein X is a bond.

13. The method of claim 6, wherein carbon fiber is at least 50% (vol) of the resulting carbon-carbon composite structure after complete carbonization.
